(19) United States
(12) Patent Application Publication
(10) Pub. No.: US 2020/0349666 A1
(43) Pub. Date: Nov. 5, 2020

(54) ENHANCED VEHICLE SHARING SYSTEM

(71) Applicant: Xirgo Technologies, LLC, Camarillo, CA (US)

(72) Inventors: Andrew Hodge, Palo Alto, CA (US); Nathan Ackerman, Palo Alto, CA (US); Jean-Paul Labrosse, Palo Alto, CA (US); Phillip Lucas Williams, Palo Alto, CA (US); Scott Lindsay Sullivan, Palo Alto, CA (US); Jason Matthew Alderman, Palo Alto, CA (US)

(73) Assignee: Xirgo Technologies, LLC, Camarillo, CA (US)

(21) Appl. No.: 16/957,068

(22) PCT Filed: Jan. 30, 2019
(86) PCT No.: PCT/US2019/015776

§ 371 Date: Jun. 22, 2020

Related U.S. Application Data
(60) Provisional application No. 62/624,263, filed on Jan. 31, 2018.

(51) Int. Cl. G06Q 50/30; G06K 7/14; G06F 21/36

(52) U.S. Cl. CPC G06Q 50/30; G06F 21/36; G06K 7/1417; G06K 7/1413

(57) ABSTRACT

Rideshare cars operate within a network and each includes a car-camera device which allows each car driver to communicate with each other. The car-camera device uses object and facial recognition software to locate objects, people, sounds, QR codes and gestures, inside and outside the car and responds accordingly, providing a corrective action. The car-camera devices perform functions to ensure that both riders and drivers of rideshare services and drivers of car-share services are safe and can communicate with each other, before, during, and after a ride or drive.

### CROSS-REFERENCE TO RELATED APPLICATIONS

This application is related to PCT Patent Application No. PCT/US17/50991, entitled “Video-Based Data Collection, Image Capture and Analysis Configuration,” filed Sep. 11, 2017, which claims the benefit of U.S. Provisional Application No. 62/412,764, filed Oct. 25, 2016, the contents of which are hereby incorporated by reference in their entirety. This application claims priority to U.S. Provisional Patent Application No. 62/624,263 filed on Jan. 31, 2018, the contents of which are incorporated herein by reference in their entirety.

### BACKGROUND

This disclosure generally relates to video-based data collection systems, and more specifically to an image, video, and sensor data capture, storage, transmission, and analysis for ride sharing applications.

With the wide adoption of smartphones and our ubiquitous connectivity to the Internet and social networks, software apps and cameras have become common place in our daily lives for personal applications. We take pictures and videos with our smartphones of all sorts of events, items, and situations, and easily upload to cloud services and share them with friends, family, and other people who subscribe or follow our shared content.

One area where cameras are being used is in vehicles. Safety cameras for backing up or side view cameras are becoming common-place. For commercial vehicles, like taxis or other vehicle fleets, security camera systems record video from both inside and outside the vehicle for safety and management purposes. For example, Safety Track of Belleville, Michigan, provides a 2-channel dash camera system equipped with a 3G/4G cellular dongle that connects to the camera system via USB for streaming video from the vehicle in real time (described at http://www.safetytrack.net/dual-lens-in-vehicle-fleet-camera-system/). However, these in-vehicle systems are not simple to install for an average consumer and lack any video sharing capabilities with other systems and do not automatically tag and share events. In-vehicle cameras are also present in vehicles used for different shared transportation options, like ridesharing services, car-sharing services, and the like. For example, ridesharing is similar to traditional carpooling, except that the driver is paid and does not usually share the passenger's final destination. The ridesharing service relies on non-professional drivers using their own vehicles connecting with passengers through social interactions and a mobile-device scheduling application. Ridesharing is able to set itself apart from conventional taxi services by employing three recent technological advances; a) GPS navigation devices which allow the driver to quickly and efficiently determine the quickest route and also arrange the shared ride; b) Smartphones with extensive and more-reliable coverage, allowing a traveler to request a ride from wherever they happen to be; and c) the continued proliferation of Social networks to establish trust and accountability between drivers and passengers. These elements are coordinated through a network service which can instantaneously manage the transfer of payment and quickly and efficiently connect nearby drivers with awaiting passengers. The end result is that passengers can enjoy almost instant arrival service, efficient routes, pre-pay convenience, and very competitive trip cost, compared to conventional taxi cab services. Another type of shared automotive transportation service is called car-sharing. Here, a person in need of a car can quickly and easily obtain one for set periods of time, as needed, such as 30 minutes. Car-sharing benefits individuals who require the use of a car, but only every so often and cannot justify the cost and hassles associated with owning a car. Car-sharing may be thought of as a form of very organized short-term car rental.

Car-sharing programs can be qualified as one of four sharing types: round trip, one-way, peer-to-peer, and fractional. In roundtrip car-sharing, members begin and end their trip, often paying by the hour, mile, or both. One-way car-sharing, on the other hand, enables members to begin and end their trip at different locations through the use of so-called free-floating zones or station-based models with designated parking locations.

Peer-to-peer car-sharing (sometimes referred to as Personal Vehicle Sharing) operates similarly to roundtrip car-sharing in trip and payment type, however, the vehicles themselves are typically privately owned or leased with the sharing system operated by a third-party. Here, the participating car owners are able to charge a fee to rent out their vehicles when they are not using them. Participating renters can access nearby and affordable vehicles and pay only for the time they need to use them.

The fractional type ownership model allows users to co-own a vehicle and share its costs and use. Car-sharing differs from traditional car renting services in at least the following ways:
Car-sharing is not limited by office hours;
Reservation, pickup, and return is all self-service;
Vehicles can be rented by the minute, by the hour, as well as by the day;
Users are members and have been pre-approved to drive (background driving checks have been performed and a payment mechanism has been established);
Vehicle locations are distributed throughout the service area, and often located for access by public transport;
Insurance: state minimum liability insurance (only $5000 in some states), comprehensive and collision insurance. They do not provide uninsured, underinsured or personal injury protection insurance;
Fuel costs are included in the rates;
Vehicles are not serviced (e.g., cleaning or fueling) after each use, although under certain programs (such as Car2Go or GoGet) the cars are continuously cleaned, fueled and maintained. Although ridesharing services have been available for several years now, they are not without problems. A growing issue revolves around trust—trust between the riders and the drivers, and trust between the drivers and the companies managing the ridesharing service, such as Uber and Lyft.

For example, as the companies try to increase their profit, they often revise current algorithms and requirements which usually end up increasing trip costs to the rider and reduce the compensation to the driver. Once such change was the introduction of so-called “surge demand” fees, which allows the cost of a trip to immediately adjust according to demand at that moment. If a particular location at a particular time, such as an airport at rush-hour, suddenly requests many rides, the cost for each trip therefrom increases, just for that moment of demand. This supply and demand cost-structure may make financial sense, but the underlying algorithms are typically misunderstood by both drivers and riders, resulting in a feeling of mistrust, because the drivers typically receive a smaller portion of the trip fee than expected and the riders-users will end up paying more for a poorer and more stressful ride experience.

Users-drivers of third-party ridesharing apps are typically independent contractors that, by many accounts, can feel at odds with the service provider company because of reasons previously mentioned. In some instances, new drivers may not be formally trained on how to handle certain situations, manage time, manage money, or even how to interact with customers (riders). The result is that drivers make mistakes—simple ones like awkward interactions with the riders, to more serious ones, such as texting while driving. The mistakes may make customers feel uncomfortable, result in accidents or injury, or at the very least, detract from at the overall ride experience.

The operation of current ridesharing services creates additional safety concerns from the moment a customer steps off the curb and enters the driver's car. A typical rideshare experience is fairly rushed with many things happening very quickly. The nature of the business leaves a passenger very little time to think. Within minutes of a person booking a ride using a mobile application, an unfamiliar car appears at the person's side, driven by someone he or she has never met and know nothing about. Without time to think about the situation, the passenger is urged to enter the car, and the car drives off. Prior to entering the car, the passenger knows nothing about the driver, except perhaps a small photo of the driver and a stock photo of the type of vehicle. The driver may be using an unauthorized vehicle that does not meet the description of the expected vehicle, or the driver may not be the registered driver the customer was expecting. The driver may have a poor driving record, may be unsafe, or may have had his or her license revoked. The passenger may have just accidently entered the wrong rideshare car or may have inadvertently requested a car that will not be suitable for the passenger's needs. To this end, there is a need for a quick, and efficient way to review a booked vehicle and assess if it fits their individual needs. Also, a passenger should be able to automatically confirm that the driver and his or her car are correctly matched and registered as being safe. The driver's driving history and the vehicle maintenance records (or score) should be quickly accessible to the passenger so that he or she may decide to accept the ride before entering the car. Another concern with the use of rideshare services is how to handle vulnerable riders, such as children, the elderly and the disabled. Under some circumstances, such “vulnerable” riders should not book their own transportation, for example if suffering of mental and physical disabilities that hinder their ability to do so. Ideally, this type of vulnerable passengers should not have to travel alone, and also not with a stranger who is unfamiliar with their special needs. Unfortunately, a busy schedule does not always accommodate time for everyone, including those with special needs. A vulnerable rider may have to make a medical appointment or attend an important event at a time when a parent or guardian is unable to transport them. Unfortunately, dedicated travel options serving many communities are notoriously slow, unknown and cost prohibitive. Rideshare services may be useful, but there are obvious concerns regarding the safety and well-being of the more vulnerable passenger during the trip. Based on this, there is a need for providing safe travel of vulnerable passengers within a rideshare environment.

Another problem with ridesharing and car-sharing is keeping track of how the passengers, in the case of ridesharing, and how the driver, in the case of car-sharing treat the vehicle they are using. Rideshare services are regularly used to transport people that have been out partying at bars and such, and as a result, the passengers are often at different levels of intoxication. It is not uncommon for a passenger to feel ill during a ride in a rideshare vehicle and get sick, including vomiting on the seats and floor. The driver may not be aware of this as he or she drives, only to find out later and have to incur the trouble of cleaning up the mess or the cost for someone else to do it. It would be reasonable to charge a passenger a clean-up fee if he or she had the misfortune to be sick in the vehicle. It would be helpful to be able to detect when this occurs and have a record of it happening so that the driver could defend any dispute arising from the application of a clean-up fee to a passenger's account.

What is needed is a ride sharing system that uses in-vehicle and user mobile device cameras to addresses the deficiencies of the prior art.

### BRIEF SUMMARY

According to various embodiments of the present invention, a video data collection and sharing platform is provided for enhanced ridesharing applications. According to embodiments, a cloud-based system for video data capture and sharing is provided. The cloud-based system may include a mobile vehicle-mounted client device comprising one or more video cameras, one or more sensors, a processor, memory, and a cellular communication module. The client device may be configured to capture video data from a moving vehicle and to generate metadata associated with the video data, including, at least in part, data derived from the one or more sensors. The system may also include a mobile device comprising a touchscreen and a wireless communication module. The mobile device may be configured to display on the touchscreen a listing of video clips available for playback by the mobile device. The cloud-based components of the system may communicate with the mobile vehicle-mounted client device via a cellular data connection, and with the mobile device via a wireless connection to the Internet. The cloud-based system provides a ridesharing communication system that provides real-time facial details of both a rideshare driver and customer at the time of pickup.

According to one embodiment, each rideshare car within a network includes a vehicle-mounted client device which allows each car driver to communicate with each other. The vehicle-mounted client device uses object and facial recognition software to locate objects, people, sounds, QR codes and gestures outside the car and to respond accordingly. In addition, customers in a rideshare car or waiting outside the car may connect their smartphone to the vehicle-mounted client device to view both the driver of the car and the view from the front of the car.

According to one embodiment, a vehicle-mounted client device may be installed in any car, including those used in car-sharing services to allow their car to be used as a rideshare vehicle at any time. The device may make a video and audio record of each ride and automatically advertise the availability of the owner's vehicle and manage scheduling and billing.

According to one aspect of one embodiment, with permission, the video captured and recorded by the vehicle-mounted client device can be viewed by a third party located outside the vehicle. This allows vulnerable passengers, such as children and the elderly to safely use a rideshare vehicle, since a sponsor can watch a live feed of the inside of the vehicle, showing the driver and the vulnerable passenger at any time during the ride. To further protect the vulnerable passenger, in one embodiment, a specially-designed rideshare vehicle includes separate lockable compartments wherein a passenger is secured in their compartment by the sponsor and only the receiving authorized sponsor is allowed to open the compartment. The driver does not have access or permission to enter the locked compartment without permission from the sponsor. According to one embodiment, a vehicle-mounted client device is connected to the vehicle's OBD port so that sensors and data of the vehicle's operation may be monitored and data stored for later review.

According to another embodiment, a vehicle-mounted client device may send a code to the correct-user's smartphone and then read the same off of the smartphone upon entering the vehicle to determine that the user is the correct rider. When the correct user is confirmed, the device may display the user's name and greet the user.

According to another embodiment, a vehicle-mounted client device monitors the inside of the car to detect if a passenger smokes or gets sick inside the vehicle. The device may create a ride-history file and make note of any such event.

According to another embodiment, a vehicle-mounted client device may also confirm that the driver is the correct registered driver for the vehicle, using appropriate facial recognition software. The vehicle-mounted client device may also scan the driver to detect certain health concerns and may warn the passenger, service provider, or employer.

According to yet another embodiment, Bluetooth beacon technology can be used to send driver information to a user waiting for a driver to arrive. After reviewing the sent driver information, the user may decide if he or she should continue with the ride, when the driver arrives at the pick-up location.

According to another aspect of one embodiment, video and audio recorded during a ride by a vehicle-mounted client device may include driver behavior, such as, attention to driving conditions, distractions, and interactions with the customers, allowing for example, training or coaching of drivers. In an effort to improve the driving skills of rideshare drivers, a training function may be provided wherein a driver is instructed to follow a prescribed test, which are audibly conveyed through speakers located within the vehicle. The driver is monitored in real-time by coaches, using the vehicle-mounted client device and the coaches may provide instant corrective feedback during the test.

The present device can also monitor a driver's eyes during a ride and send live-view alerts, for example to a passenger, ride sharing service, or employer, whenever it is determined that the driver's eyes are not looking forward and the driver appears to be distracted for a predetermined period of time.

According to another embodiment, facial recognition software used in a network of camera devices in a given area, including both stationary cameras and vehicle-mounted client devices located in nearby rideshare vehicles, the faces of people in a nearby crowd can be scanned in search of the requesting customer of a specific rideshare vehicle. If a match is found, the calculated location of the person with respect to the location of the rideshare vehicle can be used to instruct the rideshare driver how to locate his or her passenger, by announcing or displaying the instructions to position his or her rideshare vehicle nearest the located correct user. According to another aspect of one embodiment, vehicle-mounted client devices may be used to estimate the density of crowds, for example using facial recognition software or Bluetooth detection techniques, to anticipate a volume of rideshare requests from a given location. According to another embodiment, a vehicle-mounted client device may scan a crowd and quickly locate a code or pattern of color and light being projected from the smartphone of a correct user, located in the crowd. Once located, the car-camera device may then help direct a rideshare driver how to locate the newly found user by announcing or displaying the instructions to position his or her rideshare vehicle nearest the located correct user.

According to another embodiment, a cloud-based system associated with a network of vehicle-mounted client devices can provide location and availability to any third party rideshare service. With this arrangement, a driver can install a vehicle-mounted client device in their vehicle and then use the accompanying software running on the device to log into whichever rideshare service they wish to use and then enable the client device location service to the selected rideshare service. Each client device continually updates location and availability status to all enabled rideshare services.

According to another embodiment, a vehicle-mounted client device may correlate the connection between providing conveniences to a passenger during a ride and the level of rating to the driver by that passenger, after the ride.

According to another aspect of one embodiment, a vehicle-mounted client device may monitor the habits, likes and dislikes of each registered passenger to create a rider-profile which may be used by the driver to adjust ride-experience in real-time for the benefit of the passenger. According to another aspect, the vehicle-mounted client device may monitor gestures and behavioral clues made by a passenger which may indicate that an action is required, such as a passenger waving his hand in front of his or her face may indicate that there is an unpleasant odor in the vehicle, or that it is hot. The present device may then alert the driver and offer suggestions to what may be wrong, such as, in this example, opening the window or turning on the AC.

According to one embodiment, a vehicle-mounted client device is capable of data-collection, sharing and communication and may offer a variety of features which may benefit not only rideshare and car-share drivers but also civilian vehicle owners. In an effort to help a driver of a rideshare vehicle sell a client device to a passenger, the present device preferably includes a “demo” mode wherein a passenger's smartphone is linked to the present device so that the smartphone mimics the actual device.

According to another embodiment, a vehicle-mounted client device may provide a passenger a copy of the video footage of its cameras recorded during a ride, called an evidence file or “ride history” file. The file preferably includes the video footage and driver and car information, date, and time of the ride, as well as other information, such as for example, a description of the route taken, including pickup and drop-off addresses and possibly an image of a map showing the route. The evidence package may be sent as a single file to the user's email address, or as a text to the user's smartphone, if requested, or automatically sometime after the ride ends. According to another embodiment, a vehicle-mounted client device records video footage of rides of a driver during a predetermined time period and supporting software analyzes the driving skills of the driver based on specific criteria and the video footage. Based on this collected information, optionally including reports from neighboring devices in a connected network, the supporting software generates an independent safety rating of each driver and stores the rating for each testing period in the driver's profile. Should the rating drop below a threshold value, each passenger will be notified of the driver's rating and can decide if he or she wishes to decline the ride.

According to another embodiment, a passenger can connect his or her smartphone wirelessly to a vehicle-mounted client device during a ride for live-streaming video. In one embodiment, the passenger may record and save the incoming video data captured by the device, but only during the ride. A passenger may also use the vehicle-mounted client device to control a limited number of operations of the rideshare or car-share vehicle, automatically. A vehicle-mounted client device may be configured to receive and understand both voice and gesture commands by both the driver and the passenger. The passenger may control the volume levels of the radio, including turning the radio off, simply by, for example, moving his or her hand in a controlled and predetermined manner, or voicing a command “Volume Up” or “Radio Off,” or similar. The passenger may use similar command actions to control the climate controls

According to another aspect of one embodiment, a passenger may request to give a video review of a ride using the vehicle-mounted client device. In such instance, a review mode may be initiated which allows for the video and audio recording of a passenger's review of a driver. The recorded review is then stored and may be made available to future users. Further, according to another aspect of this embodiment, ratings between passengers and drivers may each be linked to video evidence during a ride to confirm the particular rating, especially useful when either the driver or the passenger is given a poor rating. For example, if the passenger is intoxicated and gets sick (i.e., throws up) in the vehicle, the driver can give the passenger a poor rating and the rideshare company can charge the passenger a “clean-up” fee to cover the cost of cleaning up the mess. If the passenger disputes the charge, the driver and the passenger will have immediate access to the video footage recorded by the present device during the ride, showing, in this example, the passenger throwing up in the back seat.

According to one embodiment, a vehicle-mounted client device may further monitor for any specific known sounds and visual clues, such as police siren and lights, suggesting a traffic stop is occurring. In this embodiment, the vehicle-mounted client device may be configured to send notifications to third parties, such as employers, service providers, or the like. According to another aspect of this embodiment, the device may request confirmation from the driver that he or she has just been pulled over by the police. If confirmed, the device may automatically contact other available rideshare vehicles in the area to pick up the passenger so he or she may continue on his or her ride.

According to another embodiment, video footage captured by a vehicle-mounted client device may be used to spot defects in the road that the vehicle is being driven on, such as potholes, and report the damage with a still picture of the damaged road and the address or GPS location to the appropriate city department of transportation as repair notification.

According to another embodiment, a vehicle-mounted client device may be used to introduce an incentive feature wherein a driver uses their smartphone to shop online and when they find an item that they would like to save up for, they can send details of that item to the vehicle-mounted client device, including a picture of the item, a description and the cost of the item. The device will then display the item and inform the driver the running total of savings towards the item and encourage the driver to continue working to save more.

According to yet another embodiment, a vehicle-mounted client device can be used to initiate and continue a conversation with a passenger, using information obtained from the Internet and the passenger's profile.

According to yet another embodiment, vehicle-mounted client device may help locate an object or person, or pet, etc. as the vehicle drives around, either with a passenger, or without. Each client device will be able to monitor a small area in front of the vehicle, but collectively and as each drive around, the effective coverage is substantial, of course depending on the number of vehicles. Object-recognition software, running within each device, may monitor the captured video footage for any desired object, including a person or an animal.

According to another aspect of one embodiment, a ridesharing vehicle enhanced with a vehicle-mounted client device may offer the passenger an opportunity to lower the cost of the trip if they promise to watch a few ads and comment on them during their ride. The passenger may select the type of ads they would like to view. The ads are managed and transmitted to the passenger's smartphone using an ad-program (email or text link) through the vehicle-mounted client device, or directly, for example via the cloud service. Once the ad completes, the passenger will be shown one or two simple multiple-choice questions regarding each ad. The passenger must answer the questions correctly to get the discount.

The features of this invention, and the manner of attaining them, will become more apparent and the invention itself will be better understood by reference to the following description of the disclosed embodiments taken in conjunction with the accompanying drawings.

### BRIEF DESCRIPTION OF THE SEVERAL VIEWS OF THE DRAWINGS

FIG. 1 illustrates an exemplary video-based data capture and analysis system according to one embodiment of the disclosure.

FIG. 2 is a functional block diagram of a client device according to one embodiment of the disclosure.

FIG. 3 is a block diagram of a vehicle-facing side of a dash camera client device according to one embodiment.

FIG. 4 is a block diagram of a view of a windshield-facing side of a camera client device according to one embodiment.

FIG. 5 is a flow chart illustrating a method for generating event-based video clips according to one embodiment.

FIG. 6 is a flow chart illustrating a rideshare communication method which helps better connect a rideshare driver with a rideshare rider at the point of pickup according to one embodiment.

FIG. 7 is a plan view of a network of vehicles operating under a common communication system, according to one embodiment.

FIG. 8 is a perspective view of the interior of a rideshare vehicle, showing a passenger linking to a client device mounted within the vehicle, according to one embodiment.

FIG. 9 is an illustrative exemplary hand of a user holding a smartphone that shows a QR code displayed thereon, according to one embodiment.

FIG. 10A is a side view of an exemplary rideshare vehicle showing a QR sticker mounted thereon, according to one embodiment.

FIG. 10B is a rear view of the exemplary rideshare vehicle of FIG. 10A, showing a QR sticker mounted to a rear window, according to one embodiment.

FIG. 11 is an illustrative exemplary hand of a user holding a smartphone with a display that shows detailed information of a correct rideshare driver and the actual rideshare driver, according to one embodiment.

FIG. 12 is an illustrative exemplary hand of a user holding a smartphone with a display that illustrates a demo mode example of a feature of the client device, according to one embodiment.

FIG. 13 is an illustrative exemplary hand of a user holding a smartphone with a display that illustrates a demo mode example of another feature of the client device, according to one embodiment.

The figures depict various example embodiments of the present disclosure for purposes of illustration only. One of ordinary skill in the art will readily recognize form the following discussion that other example embodiments based on alternative structures and methods may be implemented without departing from the principles of this disclosure and which are encompassed within the scope of this disclosure.

### DETAILED DESCRIPTION

The figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures. The above and other needs are met by the disclosed methods, a non-transitory computer-readable storage medium storing executable code, and systems for streaming and playing back immersive video content.

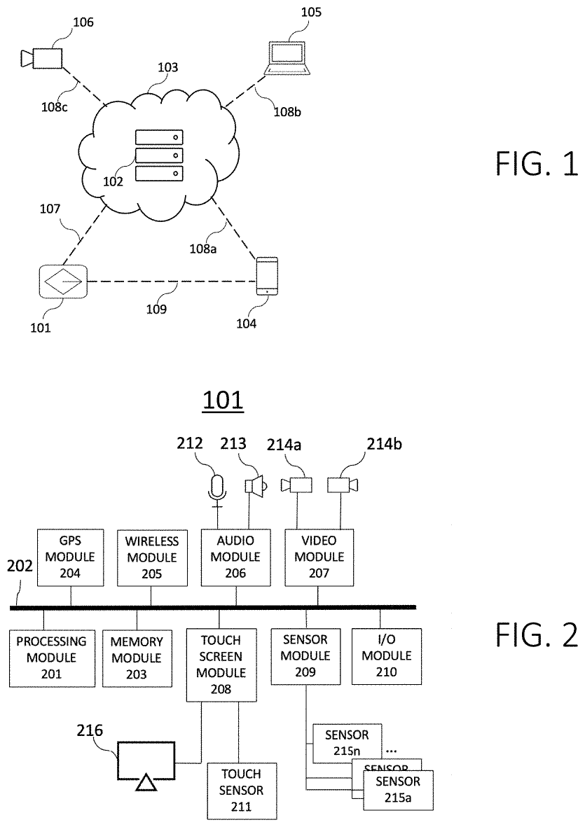

Referring now to FIG. 1, an exemplary vehicular video-based data capture and analysis system 100 according to one embodiment of the disclosure is provided. Client device 101 is a dedicated data capture and recording system suitable for installation in a vehicle. In one embodiment, client device 101 is a video-based dash camera system designed for installation on the dashboard or windshield of a car. Client device 101 is connected to cloud-based system 103. In one embodiment, cloud-based system 103 includes a server system 102 and network connections, such as for example, to Internet connections. In one embodiment, cloud-based system 103 is a set of software services and programs operating in a public data center, such as an Amazon Web Services (AWS) data center, a Google Cloud Platform data center, or the like. Cloud-based system 103 is accessible via mobile device 104 and web-based system 105. In one embodiment, mobile device 104 includes a mobile device, such as an Apple iOS based device, including iPhones, iPads, or iPods, or an Android based device, like a Samsung Galaxy smartphone, a tablet, or the like. Any such mobile device includes an application program or app running on a processor. Web-based system 105 can be any computing device capable of running a Web browser, such as for example, a WindowsTM PC or tablet, Mac Computer, or the like. Web-based system 105 may provide access to information or marketing materials of a system operations for new or potential users. In addition, Web-based system 105 may also optionally provide access to users via a software program or application similar to the mobile app further described below. In one embodiment, system 100 may also include one or more auxiliary camera modules 106. For example, one or more camera modules on a user's home, vacation home, or place of business. Auxiliary camera module 106 may be implemented as a client device 101 and operate the same way. In one embodiment, auxiliary camera module 106 is a version of client device 101 with a subset of components and functionality. For example, in one embodiment, auxiliary camera module 106 is a single camera client device 101. Client device 101 is connected to cloud-based system 103 via connection 107. In one embodiment, connection 107 is a cellular-based wireless packet data connection, such as a 3G, 4G, LTE, 5G, or similar connection. Connections 108a-108c between other system components and cloud-based system 103 are Internet-based connections, either wired or wireless. For example, in one embodiment, mobile device 104 may at different times connect to cloud-based system 103 via Wi-Fi (i.e., any IEEE 802.11-based connection or similar technology) and cellular data (e.g., using 4G, 5G, LTE, or the like). In one embodiment, Web-based system 105 is connected to cloud-based system 103 over the World Wide Web using a wired Internet connection, such as DSL, cable modem, fiber-optic cable, or the like. Similarly, in one embodiment, auxiliary camera module 106 is connected to cloud-based system 103 via a Wi-Fi connection to a home router connected to the Internet via cable modem, DSL, fiber, or the like. Any combination of available connections can be used to connect any of the system components to cloud-based system 103 via the Internet or similar networks.

Referring now to FIG. 2, a functional system diagram for a client device 101 according to one embodiment is shown. Different embodiments may include a subset of the components shown in FIG. 2 and/or other components not shown. In alternative embodiments, the components shown in FIG. 2 (as well as additional components not shown, such as for example, HDMI modules, battery charger and/or power supply modules, and the like) may be part of a System-on-Chip (SoC) device, multiple chips on a board, ASICs, or the like. The physical implementation of the components, either in silicon-based integrated circuits or software are left as a design choice of the person of ordinary skill in the art without departing from the invention. The client device 101 includes a microprocessor 201 connected to a data bus 202 and to a memory device 203 and additional functional modules. In one embodiment, microprocessor 201 is a Qualcomm Snapdragon MSM8953 but other microprocessors may be used to implement the invention, such as for example, other Qualcomm's Snapdragon processors, ARM Cortex A8/9 processors, Nvidia's Tegra processors, Texas Instruments OMAP processors, or the like. The microprocessor 201executes operating system software, such as Linux, Android, iOS, or the like, firmware, drivers, and application software.

The client device 101 in this exemplary embodiment includes a location module 204, a wireless transceiver module 205, an audio I/O module 206, a video module 207, a touchscreen module 208, a sensor module 209, and an I/O module 215. In this embodiment, the different modules are implemented in hardware and software modules. In alternative embodiments, these modules can be hardware, software, or a combination of both. For example, alternative embodiments may be provided with one or more central processor (“CPU”) cores on an SoC also including a wireless modem, multimedia processor, security and optionally other signal co-processors, such as for example, one or more graphics processor unit (“GPU”) cores, one or more holographic processing unit (“HPU”) cores, and/or one or more vision processing units (“VPU”). In one embodiment, one or more SoC processors used to embody the invention may encompass CPUs, GPUs, VPUs, HPUs, and other co-processors, motherboard buses, memory controllers, screen controllers, sound chipsets, camera modules, on-board memory, and several peripheral devices, including for example cellular, Wi-Fi, and Bluetooth transceivers, as further described below. Alternative embodiments include modules as discrete components on a circuit board interconnected by bus 202 or a combination of discrete components and one or more SoC modules with at least some of the functional modules built-in.

In one embodiment, location module 204 may include one or more satellite receivers to receive and decode signals from location satellite systems, such as Global Positioning System (“GPS”), Global Navigation Satellite System (“GLONASS”), and/or BeiDou satellite systems. In one embodiment, location module 204 is a Qualcomm QTR2965 or Qualcomm QGR7640 receiver that connects to a GPS antenna for receiving GPS satellite signals and providing geographical coordinates (latitude and longitude) of the location of the client device 101. The wireless transceiver module 205 includes a cellular modem, e.g., compliant with 3G/UMTS, 4G/LTE, 5G or similar wireless cellular standards, a Wi-Fi transceiver, e.g., compliant with IEEE 802.11 standards or similar wireless local area networking standards, and a Bluetooth transceiver, e.g., compliant with the IEEE 802.15 standards or similar short-range wireless communication standards. In one embodiment, the wireless transceiver module 205 is a Sierra Wireless HL-7588.

The audio I/O module 206 includes an audio codec chipset with one or more analog and/or digital audio input and output ports and one or more digital-to-analog converters and analog-to-digital converters and may include one or more filters, sample rate converters, mixers, multiplexers, and the like. For example, in one embodiment, a Qualcomm WCD9326 chipset is used, but alternative audio codecs may be used. In one embodiment, video module 207 includes a DSP core for video image processing with video accelerator hardware for processing various video compression formats and standards, including for example, MPEG-2, MPEG-4, H.264, H.265, and the like. In one embodiment, video module 207 is integrated into an SoC “multimedia processor” along with processor 201. For example, in one embodiment, client device 101 includes an integrated GPU inside the Qualcomm MSM8953 but alternative embodiments may include different implementations of video module 207.

In one embodiment, the touchscreen module 208, is a low-power touchscreen sensor integrated circuit with a capacitive touchscreen controller as is known in the art. Other embodiments may implement touchscreen module 208 with different components, such single touch sensors, multi-touch sensors, capacitive sensors, resistive sensors, and the like. In one embodiment, the touchscreen module 208 includes an LCD controller for controlling video output to the client device's LCD screen. LCD controller may be integrated into a touchscreen module 208 or, in alternative embodiments, be provided as part of video module 207, as a separate module on its own, or distributed among various other modules.

In one embodiment, sensor module 209 includes controllers for multiple hardware and/or software-based sensors, including, accelerometers, gyroscopes, magnetometers, light sensors, gravity sensors, geomagnetic field sensors, linear acceleration sensors, rotation vector sensors, significant motion sensors, step counter sensors, step detector sensors, and the like. For example, in one embodiment, sensor module 209 is and Invensense ICM-20608. Alternative implementations of sensor module 209 may be provided in different embodiments. For example, in one embodiment, sensor module 209 is an integrated motion sensor MEMS device that includes one or more multi-axis accelerometers and one or more multi-axis gyroscopes. Client device 101 may also include one or more I/O modules 210. In one embodiment, I/O module 210 includes a Universal Serial Bus (USB) controller, a Controller Area Network (CAN bus) and/or a LIN (Local Interconnect Network) controller, On-Board Diagnostics (OBD) port interface.

In one embodiment, client device 101 also includes a touchscreen 211. In alternative embodiments, other user input devices (not shown) may be used, such a keyboard, mouse, stylus, or the like. Touchscreen 211 may be a capacitive touch array controlled by touchscreen module 208 to receive touch input from a user. Other touchscreen technology may be used in alternative embodiments of touchscreen 211, such as for example, force sensing touch screens, resistive touchscreens, electric-field tomography touch sensors, radio-frequency (RF) touch sensors, or the like. In addition, user input may be received through one or more microphones 212. In one embodiment, microphone 212 is a digital microphone connected to audio module 206 to receive user spoken input, such as user instructions or commands. Microphone 212 may also be used for other functions, such as user communications, audio component of video recordings, or the like. Client device may also include one or more audio output devices 213, such as speakers or speaker arrays. In alternative embodiments, audio output devices 213 may include other components, such as an automotive speaker system, headphones, stand-alone “smart” speakers, or the like.

Client device 101 can also include one or more cameras 214, one or more sensors 215, and a screen 216. In one embodiment, client device 101 includes two cameras 214a and 214b. Each camera 214 is a high definition CMOS-based imaging sensor camera capable of recording video one or more video modes, including for example high-definition formats, such as 1440p, 1080p, 720p, and/or ultra-high-definition formats, such as 2K (e.g., 2048×1080 or similar), 4K or 2160p, 2540p, 4000p, 8K or 4320p, or similar video modes. Cameras 214 record video using variable frame rates, such for example, frame rates between 1 and 300 frames per second. For example, in one embodiment cameras 214a and 214b are Omnivision OV-4688 cameras. Alternative cameras 214 may be provided in different embodiments capable of recording video in any combinations of these and other video modes. For example, other CMOS sensors or CCD image sensors may be used. Cameras 214 are controlled by video module 207 to record video input as further described below. A single client device 101 may include multiple cameras to cover different views and angles. For example, in a vehicle-based system, client device 101 may include a front camera, side cameras, back cameras, inside cameras, etc.

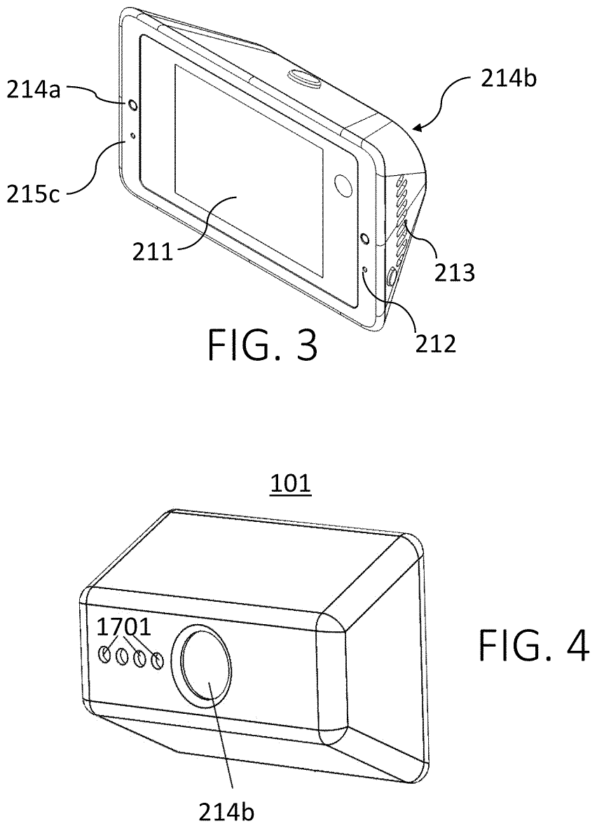

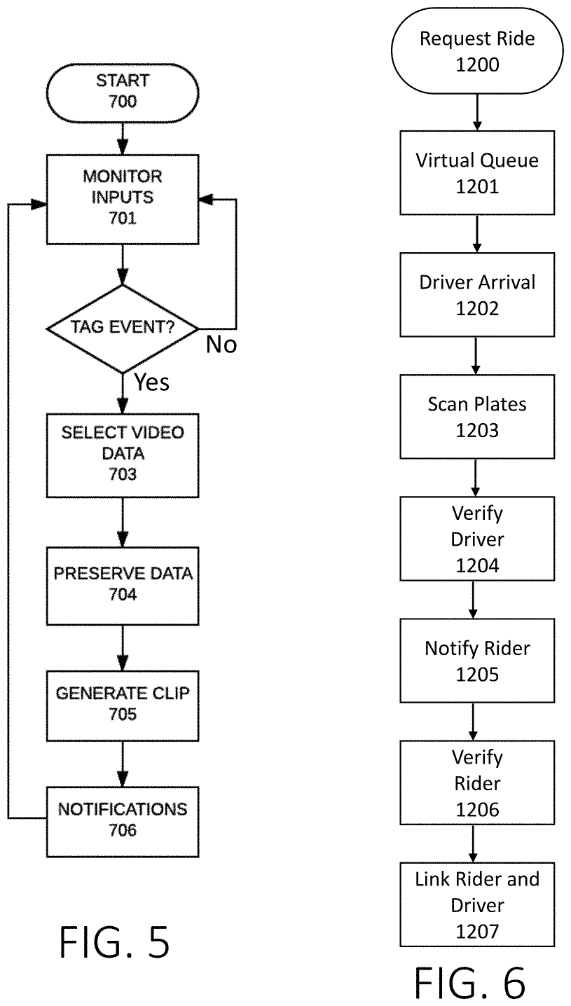

Client device 101 can include one or more sensors 215. For example, sensors 215 may include one or more hardware and/or software-based sensors, including, accelerometers, gyroscopes, magnetometers, light sensors, gravity sensors, geomagnetic field sensors, linear acceleration sensors, rotation vector sensors, significant motion sensors, step counter sensors, step detector sensors, and the like. In one embodiment, client device 101 includes an accelerometer 215a, gyroscope 215b, and light sensor 215c. FIG. 3 and FIG. 4 provide views of an illustrative embodiment of a client device implemented as a dash camera system according to the invention. Referring back to FIG. 1, another component of system 100 is a mobile device 104. Mobile device 104 may be an Apple iOS based device, such as an iPhone, iPad, or iPod, or an Android based device, such as for example, a Samsung Galaxy smartphone, a tablet, a PDA, or the like. In one embodiment, mobile device 104 is a smartphone with one or more cameras, microphone, speakers, wireless communication capabilities, and sensors. For example, mobile device 104 may be an Apple iPhone 7. The wireless communication capabilities of mobile device 104 preferably include wireless local area networking communications, such as 802.11 compatible communications or Wi-Fi, short-range low-power wireless communications, such as 802.15 compatible communications or Bluetooth, and cellular communications (e.g., 4G/LTE, 5G, or the like). In addition, mobile device 104 preferably includes an application program or app running on a processor. One of ordinary skill in the art is familiar with mobile operating systems and mobile apps. Mobile apps are typically made available and distributed through electronic means, such as for example, via electronic “stores” such as the Apple App Store or the Google Play Store, or directly from apps providers via their own websites. It should be noted that mobile device app is not required for operation of the system, for example, camera device 101/108 may include a voice-enabled interface, a chat-bot interface, or the like. However, several embodiments include the use of a mobile app as further described below. Now referring to FIG. 5, a method for generating event-based video clips according to one embodiment is described. Upon activation of the system, the method starts 700. The various inputs are monitored 701 while video is continuously captured and stored in the buffer, for example in two-second clips or video objects. If no tagging event is detected 702, the system keeps monitoring. If a tagging event is detected 702, the relevant video data in the buffer is identified and selected 703. For example, once an event is detected 702, video files for a predefined period of time before and after the event is identified in the buffer. In one example, 15 seconds before and after the event time is used. The amount of time, preferably between 10 and 30 seconds, may be pre-programmed or user selectable. Further, two different time periods may be used, one for time before the event and the other for time after the event. In one embodiment, the time periods may be different depending on the event detected. For example, for some events the time periods may be 30 seconds before event and 1 or 2 minutes after while other events may be 15 seconds before and 15 seconds after.

The selected video data is marked for buffering 704 for a longer period of time. For example, the video files for the selected time period are copied over to a second system buffer with a different buffering policy that retains the video for a longer period of time. In one embodiment, the selected video data being in a buffer storing video for 24 hours is moved over to a second buffer storing video for 72 hours.

Referring back to FIG. 5, a video clip is then generated 705 with the selected video data. Every video clip generated is associated with a globally unique identifier (GUID). In one embodiment, video clips are generated using a playlist file or manifest file as is known in the art. Each playlist or manifest file includes a GUID. For example, in one embodiment, an m3u8 playlist file is generated according to the HTTP Live Streaming specification (as for example described in Internet Draft draft-pantos-http-live-streaming-23 submitted by Apple, Inc. to IETF on May 22, 2017). Alternative video clip generating techniques may be used in other embodiments, including, for example, MPEG-DASH (ISO/IEC 23009-1), Adobe's HTTP Dynamic Streaming, Microsoft's Smooth Streaming, or the like. The playlist or manifest file provides network-based location for the video data objects selected 703. For example, a Universal Resource Locator (URLs) may be provided for each of a set of video files. Using this approach, the video data can be stored in any network accessible storage. For example, video files identified in a given playlist can be stored on a camera device (e.g., client device 101, auxiliary camera 106, or mobile device 104) and network address locators are provided for each file at that location. In alternative embodiments, other video clip generation approaches may be used. For example, in one embodiment, the selected 703 video data is used to generate a single video file, such as an MPEG video file, that may be uploaded and downloaded as needed.

In one embodiment, video data objects are stored on the network-accessible buffer of the camera device and the playlist or manifest files for the generated event-based video clips identify the network addresses for the memory buffer memory locations storing the video data objects or files. Alternatively, upon identifying and selecting 703 the relevant video data objects, in addition to or as an alternative to moving the video data to the longer buffer 704, the video data may be uploaded to the cloud system 103. The clip generation 705 then identifies in the playlist or manifest file the network addresses for the video data stored in the cloud system 103. A combination of these approaches may be used depending on storage capacity and network capabilities for the camera devices used in the system or according to other design choices of the various possible implementations.

In one embodiment, other system components, such as the cloud system 103 or mobile device 104, are notified 706 of the event or event-based video clip. For example, in one embodiment a message including the GUID for the generated video clip is sent to the cloud system in a cryptographically signed message (as further discussed described in the incorporated PCT/US17/50991 patent application). Optionally, the playlist or manifest file may also be sent in the message. In one embodiment, the playlist or manifest files are maintained in the local memory of the camera device until requested. For example, upon notification 706 of the clip generation, the cloud system may request the clip playlist or manifest file. Optionally, the cloud system may notify 706 other system components and/or other users of the clip and other system components or users may request the clip either from the cloud system 103 or directly from the camera device. For example, the clips pane 401a in the user's mobile app may display the clip information upon receiving the notification 706. Given that the clip metadata is not a large amount of data, e.g., a few kilobytes, the user app can be notified almost instantaneously after the tag event is generated. The larger amount of data associated with the video data for the clip can be transferred later, for example, via the cloud system or directly to a mobile device.

Once a video clip is generated 705, it may be shared with other devices owned by the same user or, if authorized, the video clip may be shared with other users of the system, such as for example ridesharing service providers, customers, or the like. For example, the GUIDs for every video clip generated by a camera device of a given driver may be stored in a user clip table in the cloud system 103. For example, GUIDs for the clips from all the cameras on a multi-camera client device 101, for the clips from any auxiliary camera device 106, and for the clips generated by the mobile app on the user's mobile device 104, may all be stored in the user clip table. The user may access the user clip table via mobile device 104. For example, mobile app may maintain a user clip table that is synchronized with the user clip table in the cloud system. Every time a new clip notification is received, the mobile app and cloud-based user clip tables are updated and or synchronized. Alternative synchronization approaches may be used, such as for example a periodic synchronization approach.

According to another aspect of the disclosure, detection of tagging events 702 may be done automatically by the system. For example, based on the monitored inputs, in different embodiments events such as a vehicle crash, a police stop, or a break in, may be automatically determined. Similarly, in a ridesharing embodiment, driver-specific or rider-specific events may be automatically determined. The monitored inputs 701 may include, for example, image processing signals, sound processing signals, sensor processing signals, speech processing signals, in any combination. In one embodiment, image processing signals includes face recognition algorithms, body recognition algorithms, and/or object/pattern detection algorithms applied to the video data from one or more cameras. For example, the face of a user, driver, or passenger, may be recognized being inside a vehicle. As another example, flashing lights from police, fire, or other emergency vehicles may be detected in the video data. Another image processing algorithm detects the presence of human faces (but not of a recognized user), human bodies, or uniformed personnel in the video data. Similarly, sound processing signals may be based on audio recorded by one or more microphones 212 in a camera device, (e.g., client device 101, auxiliary camera 106, or mobile device 104).

Sound processing may also include speech recognition and natural language processing to recognize human speech, words, and/or commands. For example, certain “trigger” words may be associated with particular events. When the “trigger” word is found present in the audio data, the corresponding event may be determined. Similarly, the outputs of the available sensors may be received and processed to determine presence of patterns associated with events. For example, GPS signals, accelerator signals, gyroscope signals, magnetometer signals, and the like may be received and analyzed to detect the presence of events. In one embodiment, additional data received via wireless module 205, such as traffic information, weather information, police reports, or the like, is also used in the detection process. The detection process 702 applies algorithms and heuristics that associate combinations of all these potential inputs with possible events.

The event detection algorithms may be implemented locally on the camera device (e.g., client device 101) or may be performed in cloud servers 102, with the input signals and event detection outputs transmitted over the wireless communication connection 107/108 from and to the camera device. Alternatively, in some embodiments a subset of the detection algorithms may be performed locally on the camera device while other detection algorithms are performed on cloud servers 102, depending for example, on the processing capabilities available on the client device. Further, in one embodiment, artificial intelligence (“AI”) algorithms are applied to the multiple inputs to identify the most likely matching event for the given combination of inputs. For example, a neural network may be trained with the set of inputs used by the system to recognize the set of possible tagging events. Further, a feedback mechanism may be provided to the user via the mobile app to accept or reject proposed tagging results to further refine the neural network as the system is used. This provides a refinement process that improves the performance of the system over time. At the same time, the system is capable of learning to detect false positives provided by the algorithms and heuristics and may refine them to avoid incorrectly tagging events.

According to another aspect of the disclosure, in one embodiment, the detection process 702 is configured to detect a user-determined manual tagging of an event. The user may provide an indication to the system of the occurrence of an event of interest to the user. For example, in one embodiment, a user may touch the touchscreen of a client device 101 to indicate the occurrence of an event. Upon detecting 702 the user “manual tag” input, the system creates an event-based clip as described above with reference to FIG. 5. In an alternative embodiment, the user indication may include a voice command, a Bluetooth transmitted signal, or the like. For example, in one embodiment, a user may utter a predetermined word or set of words (e.g., “Owl make a note,” “OK, presto,” or the like). Upon detecting the utterance in the audio input, the system may provide a cue to indicate the recognition. For example, the client device 101 may beep, vibrate, or output speech to indicate recognition of a manual tag. Optionally, additional user speech may be input to provide a name or descriptor for the event-based video clip resulting for the user manual tag input. For example, a short description of the event may be uttered by the user. The user's utterance is processed by a speech-to-text algorithm and the resulting text is stored as metadata associated with the video clip. For example, in one embodiment, the name or descriptor provided by the user may be displayed on the mobile app. In another embodiment, the additional user speech may include additional commands. For example, the user may indicate the length of the event for which the manual tag was indicated, e.g., “short” for a 30-second recording, “long” for a two-minute recording, or the like. Optionally, the length of any video clip can be extended based on user input. For example, after an initial event-based video clip is generated, the user may review the video clip and request additional time before or after and the associated video data is added to the playlist or manifest file as described with reference to FIG. 5.

In one embodiment, the tagging process may optionally be programmable. For example, camera device may be programmed to recognize traffic signs using image recognition and a classifier and to capture and store metadata associated with the recognized sign. For example, stop signs may be detected and the speed or other sensor data may be recorded as metadata associated with the stop sign. This feature may be used by third-parties for monitoring driving behavior. For example, parents can monitor children, insurance companies can monitor insureds, employers can monitor employees, car-sharing companies can monitor user behavior, ridesharing services can monitor drivers and passengers, etc. Optionally, in one embodiment the camera device may provide driver feedback based on the detected signs and sensor data. For example, in one embodiment, the camera device may recognize street parking signs and notify the user regarding parking limits. For example, the device may alert the user regarding a “No Parking” zone, a limited time parking zone, and/or remind the user prior to the expiration of a parking time limit with sufficient time for the user to return to the vehicle (e.g., based on the sign image recognition, time, and location information). One of ordinary skill in the art would recognize the additional applications of driver feedback are possible within the scope of the invention, such as for example, feedback regarding speeding, traffic light/sign compliance, safety, or the like.

According to another embodiment of the invention, client device 101 preferably includes two or more cameras 214, one directed inside the cabin of the vehicle 214a and one directed outside 214b, as for example shown in FIG. 3 and FIG. 4. According to this embodiment, object recognition software running on client device 101 will continuously analyze recorded video of inside the vehicle for various reasons, including detection of a lit cigarette or cigar. The software will search for the tell-tale signature of a smoker, by first identifying the general features of the human face of each person in the vehicle, and then search for a small bright illuminated circle located near the person's mouth, which would illuminate brightly for less than about 5 seconds. The bright glowing circle would be an indication that a person is inhaling a cigarette, for example, which would cause the lit end of the cigarette to glow with increased intensity owing to the temporary increase in the flow of oxygen. Client device 101 (or another separate device) may include a thermal sensor 215 that is dedicated to identify such “hot spots” within a vehicle which, if found, would likely indicate that a person is smoking inside the vehicle. If it is determined that a person is smoking the vehicle, an alarm may sound, and/or a record of such an event would be recorded and preferably also transmitted to the remote cloud system 103. This smoker-detection feature can be used for example, in ridesharing services to verify that smoke-free vehicles are provided, or for example, in the car-rental industry (and other agencies and companies that use fleets of vehicles in their operation) wherein it is important to keep track of when a person driving or riding in one of their vehicles is or has smoked while in the vehicle

According to another one embodiment, client devices 101 operate continuously, even when the vehicle in which the device is installed is parked. Cameras 214 in a set of networked devices 101/106 can be instructed to record video continuously and the captured video footage can be continuously analyzed by the microprocessor and an appropriate object recognition software. With this arrangement, a parked vehicle with a running client device 101 may be used to capture speeding vehicles in a neighborhood, for example. Any vehicle whose measured speed exceeds a threshold value can trigger client device to notify local police, for example via cloud system 103. Information gathered from many vehicles with many operating client devices may be used to establish areas in a locale where speeding is prevalent. If a vehicle is speeding, the vehicle's client device can notify the driver through an audible or visual signal (such as flashing LED lights) that he or she is speeding. Client device 101 can also be used to verify that the driver is meeting other safety requirements, such as keeping two hands on the steering wheel while driving, and not texting, etc.

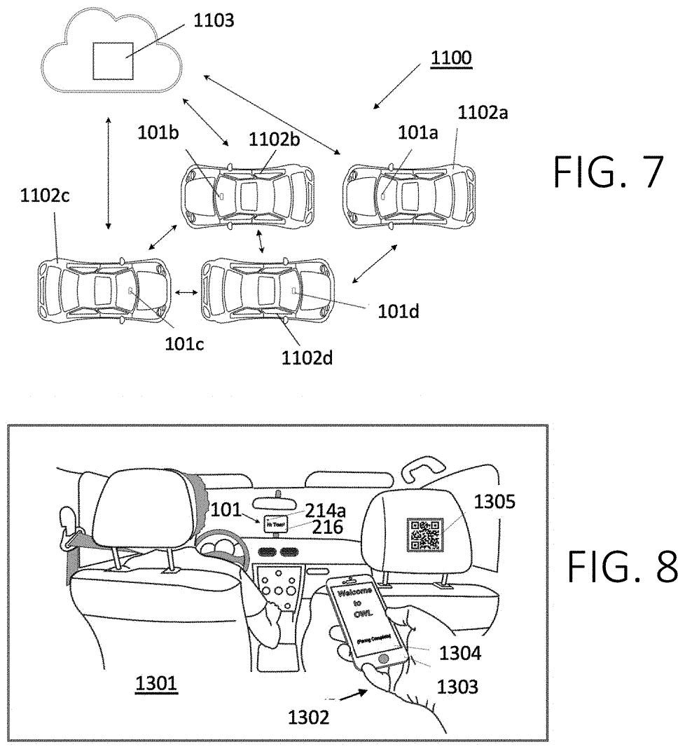

Referring now to FIG. 7, a networked ridesharing system 1100 is illustrated according to a ridesharing embodiment of the invention. The system 1100 includes vehicles 1102a-1102d of participating rideshare drivers. Each vehicle 1102 within system 1100 includes a vehicle-mounted client device 101a-101d, respectively, that may be further enhanced for ridesharing or car-sharing functionality as described below. The vehicle-mounted client devices 101a-101d may communicate directly with each other, e.g., peer-to-peer, and/or with cloud system 1103 using any network topology, to establish a network of ridesharing vehicle-mounted devices. Ridesharing vehicle-mounted client device 101 may for example be mounted to the windshield of a ridesharing or car-sharing vehicle, positioned on the vehicle's dashboard, or otherwise installed in the vehicle.

A typical rideshare service allows a user needing a ride to request a rideshare pickup at their present location. They use a mobile application on their mobile device to request the ride. The application “knows” (through GPS of the mobile device) the user's current location, and the locations of nearby registered drivers. The user inputs the desired destination and the program calculates a total price for the trip. The request details automatically appear on the mobile devices or client devices of nearby drivers. Once a driver accepts the request, the user requesting the ride gets confirmation on their mobile device, including a picture of the driver and a stock photo of the driver's car, an estimated time of arrival and a map showing the relative location of the approaching rideshare vehicle. When the driver arrives at the pickup location, the user waiting for the ride receives notification on their mobile device and begins to look for the approaching rideshare vehicle. If the user is alone at an empty location, finding the arriving rideshare vehicle is likely straightforward. However, if there is a crowd of people around and many vehicles arriving and departing from the curb, such as any typical moment of time at an airport terminal, confusion may quickly ensue and locating the correct rideshare vehicle can prove to be difficult.

Referring now to FIG. 6, according to yet another embodiment, an enhanced rideshare communication method is provided which helps better connect a rideshare driver with a rideshare rider at the point of pickup. According to this embodiment, the process begins with a rider using a rideshare application on their smartphone to request a ride 1200, for example, from inside a business location. In one embodiment, the rideshare application may use GPS location information to instruct the rider to wait at a specific location nearby, such as a “Smart Stop” (which is a predefined area at a business or other location that is reserved for people waiting to be picked up by a rideshare service vehicle). The rideshare application then places the customer into a virtual queue 1201, while the request is being responded to by a driver in the system. While in the virtual queue, the system may store information from both the rider and the driver who accepts the request. When the driver arrives at the pickup location, the driver client device sends an arrival notification 1202 to the system. At this time, cameras located in the pickup area scan license plate information 1203 of any arriving vehicle, to confirm arrival of the driver. The plate scanning cameras may be any type of client device 101, including auxiliary camera modules 106, for example, fixed to poles, structures, or buildings in or around the pick-up location, mobile device 104 cameras of other riders, in-vehicle client devices 101 from other drivers, or the like. Once the driver vehicle plate is detected, the system links with the client device 101 located in the driver's vehicle to verify 1204, through facial recognition, that the current driver matches the rideshare driver profile information in the system. If the driver is verified 1204, then the rider receives notification 1205 through the rideshare application, or another supporting application, that the rideshare vehicle has arrived and that the driver has been verified. The rider is then asked to submit to a facial scan, for example, in one embodiment, the driver is asked to point a mobile device 104 camera to his or her face. In another embodiment, the rider is asked to stand in front of an auxiliary camera 106 provided at the pick-up location for a facial scan. The system verifies 1204 the rider, using facial recognition to confirm that the rider's profile stored by the system matches his or her face. The system then notifies the driver that the rider is present. In one embodiment, the driver and rider are then linked 1207 by, for example, sending a picture of the driver to the rider and a picture of the rider is to the driver so that both people can more easily locate each other. Alternatively, a picture of the vehicle can also be provided.

According to another embodiment, the rideshare driver's client device 101 will perform as an augmented reality device wherein a graphic box, for example, or any other graphic is displayed on to display 216 along with a real-time image of a field of view of a front facing camera 214, such as an image of several people waiting on a curb. With this arrangement, the exact location of the awaiting rider is determined, for example, using local RF beacons identifying the mobile device 101 of the rider (e.g., via Bluetooth ID), using facial recognition from a plurality of client device cameras at the pick-up location to triangulate the location of the rider, using facial recognition from the driver's front-facing camera 214 to identify the scanned face of the rider in the crowd, or using a similarly suitable approach. The rider exact location is then used to position a graphic above or over the rider as viewed through the augmented reality display 216. According to yet another embodiment of the invention, a secondary display located within the driver's vehicle and facing out automatically displays a picture of the rider when the driver arrives at the pick-up location. With this arrangement, the rider waiting on the curb can see his or her own picture and can thereby quickly and accurately determine that the arriving rideshare vehicle is meant for him or her. The picture can be from the rider's profile that is provided during initial setup of the rideshare account, or when the rider schedules a pick up, or at some other time.

Referring to FIG. 8, a ridesharing vehicle embodiment 1301 is illustrated. In this embodiment, cabin-view camera 214a of client device 101 is positioned so that its field of view covers a majority of the interior of the vehicle, preferably including the driver and the front passenger seat, as well as any unblocked portion of the rear seat of the vehicle. With this arrangement, if a passenger is seated in either the front or rear seat of the vehicle, client device 101, using cabin-view camera 214a, will be able to capture and record at least details of the passenger's face, and preferably also portions of the passenger's arms and hands 1302. Additional cabin-view cameras 214 (not shown) may be used in other embodiments to provide additional video data from the interior of the vehicle. Display 216 of client device 101 is preferably large enough to be viewed by a rear seated passenger, as shown in FIG. 8, wherein, in this example, display 216 may show a rider salutation, e.g., “Hi Tom,” directed to a passenger who may be seated in the rear seat. In alternative embodiments, the user's own mobile device or a back-seat display may be used for this purpose. For example, FIG. 8 shows a passenger's hand 1302 holding a smartphone device 1303, which includes a display 1304. In this case, a mobile application used in connection with client device 101 is shown on the display 1304 of the passenger's smartphone device 1303.

Forward-view camera 214b (shown in FIG. 4) of client device 101 is positioned so that its field of view covers a majority of the view at the front of the vehicle. The video footage captured by the two cameras 214a, 214b of client device 101 is used to enable several improved functions, according to various embodiments for both ridesharing and car-sharing applications. According to one embodiment, any person connected to system 1100 who owns a vehicle 1102 and has a client device 101 installed therein may host rides for requesting users. Any user needing a ride may use their mobile device and the ridesharing mobile application to request a ride from other users within system 1100. According to another embodiment, a companion mobile application may be used to connect people with each other based on proximity, route similarity, similar interests, etc. to share a rideshare ride, similar to carpooling, but with a rideshare driver.

According to one embodiment, the owner of a vehicle with client device 101 installed therein may use client device as a hub for sharing use of their personal vehicle when it is not otherwise needed. An operation mode of client device 101 automatically advertises the availability of the owner's vehicle and manages scheduling and billing. Client device 101 may monitor all activity within the vehicle and record video footage of the forward part of the vehicle as it is being driven. Live video feeds may be activated by a third party, or the owner of the vehicle and two-way audio and video communication may be performed at any time, with the remote video feed being displayed on display 216 of device 101. Client device 101 may be connected to the vehicle's OBD port so that sensors and data of the vehicle's operation may be monitored and data stored for later review.

According to another one embodiment, in a specific mode of operation, the microprocessors of networked client devices 101a-d (located in various nearby rideshare vehicles within system 1100) running an appropriate object-recognition software in real-time continuously analyze the content of the video feed from forward-view cameras 214b of client devices 101a-d, searching the people located near the curb (or other locations) for known objects located on or adjacent to their respective bodies. In response to detecting specific known objects, such as luggage, a briefcase, shopping bags, a business suit, etc., a specific type of rideshare vehicle may be suggested (e.g., a limousine, a larger SUV, a smaller sedan, etc.). For example, if luggage is detected, the client device will logically predict that the people are traveling to the airport, and perhaps casual sports attire suggests that the person is traveling to a sporting event. By predicting the type of passenger and the logical destination, the system can offer a group ride to rideshare drivers by allowing rideshare drivers who use a client device 101 to offer the group ride to each of common type users. This can be done through client device 101 prior to the rideshare application connecting the individual requests to nearby rideshare drivers who are not using client device 101.

According to another one embodiment, in a specific mode of operation, similar to the above-described embodiment, the microprocessors of client devices 101a-d (located in any one of various rideshare vehicles operating within system 1100) running an appropriate object-recognition software in real-time continuously analyze the content of the video feed from forward-view cameras 214b of client devices 101a-d, monitoring people located on a nearby curb or another location in view of cameras 214b field of view for known gestures, such as a person raising one arm up likely means that he or she is trying to hail a cab.

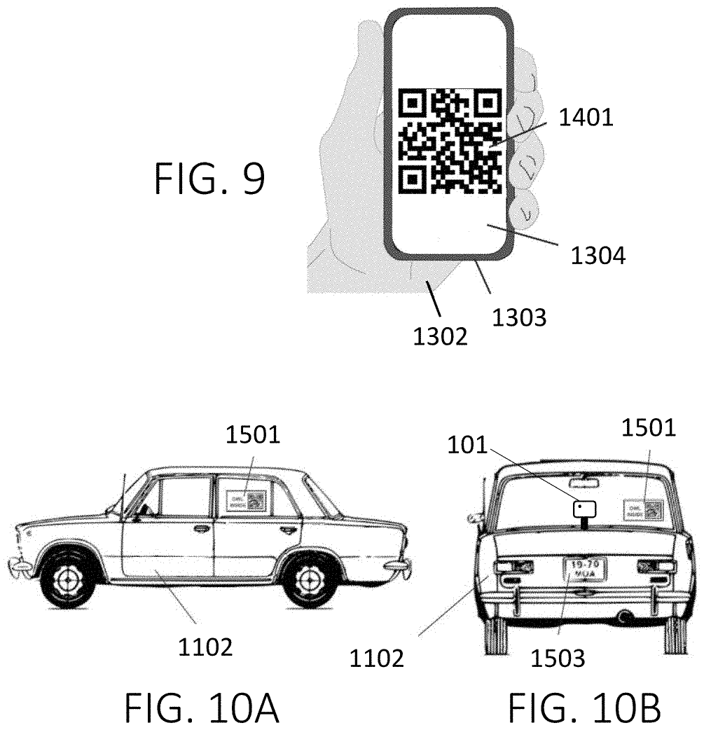

According to this embodiment, and referring to FIG. 9, a user may quickly and easily selectively display a unique QR code 1401 on display 1304 of smartphone 1303 to help summon a rideshare service from alongside a road. In situations in which a user in need of a ride is intoxicated and is unable to effectively request a ride-share ride using the mobile application, the user merely has to push few buttons to display QR code 1401 on their smartphone display 1304, and then hold their smartphone up so QR code 1401 can be viewed by passing cars, including vehicles 1102 operating in the system 1100. In response to a positive detection of this “hailing” gesture, and a successful scan of displayed QR code 1401, according to this embodiment, client device 101 automatically extracts the user's membership ID number from the QR code and informs other rideshare drivers (using client devices 101) that a person having the identified membership ID number is located at the detected location (as determined by GPS) and appears to be in need of a ride. QR code 1401 may also be printed on a card or provided on another medium to be carried by a user until needed. Also, QR code 1401 preferably conveys a home address of the user so that any rideshare responding to the call will already have the user's default address (home) simply by scanning the code. For example, the membership ID number derived from the QR code may be used to access the user's membership record, which may include the user's home address.

Referring back to FIG. 8, and according to another aspect of one embodiment, whenever a person enters a networked rideshare vehicle 1102, the person may hold up the display of their mobile device 1303 to the cabin-view camera 214a of client device 101 so that the camera can analyze the displayed content and compare the information with that of the true user who requested the ride. This “visual handshake” may include a displayed QR code 1401 on the user's smartphone which is quickly scanned, translated, and compared with known stored user-ID information. If a match is made, the person will be notified, such as with a bell sound, or announcing the rider's name: “Welcome Tom!”, and the ride can then commence. At the point of this confirmation, a true start time for the ride can be registered. The information displayed on the person's mobile device can be any of many suitable identification codes or data (e.g., Bluetooth ID), or even an image (e.g., using face recognition). If a match cannot be confirmed, the person will be alerted accordingly (e.g., a different sound), whereby the driver will ask for additional information, or will try to locate the person's correct rideshare vehicle.

Alternatively, a known and understood gesture or action may be presented by the user as he or she enters the vehicle, such as holding up three fingers in front of the cabin-view camera 214a of client device 101. This gesture or action can be recorded, analyzed and compared to a prescribed gesture previously selected by the user and stored in the user's account profile. If the gestures match, then the user is the correct rider.

Also, as shown in FIG. 8, an interior QR code 1305 may be provided on a portion of the interior of the vehicle. Interior QR code 1305 shown here is meant to be scanned in by passenger using his or her smartphone 1303 to automatically display information, such as who the correct, registered driver looks like (and other driver information—driving record, score, etc.), how to purchase a client device 101, or provide any of the features described herein associated with passengers' smartphone devices 1303.

According to another aspect of this embodiment, to help protect the driver, client device 101 may also detect the motions and voice and other actions of the user as he or she enters the vehicle and, for example, may determine that he or she appears to be intoxicated or perhaps smokes. If so, client device 101 will make note of this in the ride history file, generate an event-based video clip (as described above with reference to FIG. 5) and save the video footage of the ride. Also, during a ride, if the passenger becomes sick and throws up in the vehicle, or smokes, client device 101 may automatically detect these events by monitoring the actions and movements and other behavioral clues associated with these “behavioral events” and actions and either alert the driver at that moment, generate an event-based video clip, or at least make note of it in the ride history file.

In one embodiment, the ride history file preferably includes the video footage from both cameras, audio data, the GPS data showing pickup location, drop-off location, the route and times, and any automatically detected events that occurred during the ride, such as the passenger throwing up, smoking, becoming violent, hitting the seats or windows, yelling or shouting profanities, making out with another passenger, threatening the driver, etc. The ride history of each ride is sent to the ridesharing cloud server 1103 for storage and safekeeping. The ride history is accessible to both the driver and the rider, in certain situations and with permission. A link can be sent to both the driver and the passenger by text or email, if requested within a predetermined period of time.

The ride history can be used to protect both the passenger and the driver. If the passenger smokes or vomits in the vehicle, the driver can use the ride history file as proof to justify charging the passenger an additional clean-up fee to his or her account after the ride ends. According to another aspect of one embodiment, client device 101 can also confirm that the driver is the correct registered driver for the vehicle, using appropriate facial recognition software and cabin-view camera 214a. In one embodiment, the vehicle 1102 cannot be driven after the user enters the vehicle until client device 101 confirms that the user is the correct rider and also that the driver is verified as being the correct driver. Alternatively, in another embodiment, an application may display a warning that the driver's identity has not yet been verified and payment to the driver can be withheld until verification is achieved. These requirements would discourage a verified driver from allowing another person to take his or her place as “the driver” of the rideshare vehicle.

According to another aspect of one embodiment, the footage of cabin-view camera 214a is processed by software in client device 101 to perform a facial scan of the driver, either periodically, or after accepting a user's ride request. The scan would be able to detect certain health concerns with some accuracy, such as drowsiness, fatigue, and intoxication. Most of the scanning effort would be concentrated in the driver's eyes, scanning them to determine if the eyes are dilated, for example, which could indicate that the driver did not get enough sleep. In one embodiment, if the driver does not cooperate with the testing procedure, by looking away, for example, or the testing cannot otherwise be performed, then the driver will not be able to accept a user's ride request.

According to this embodiment, the health scan results of the driver and the last one or two passenger reviews is sent to the user after the driver accepts his or her ride request. The user may then review the results and decide if he or she wishes to continue with the ride. If not, the user may request another ride from a different driver and cancel the current one.

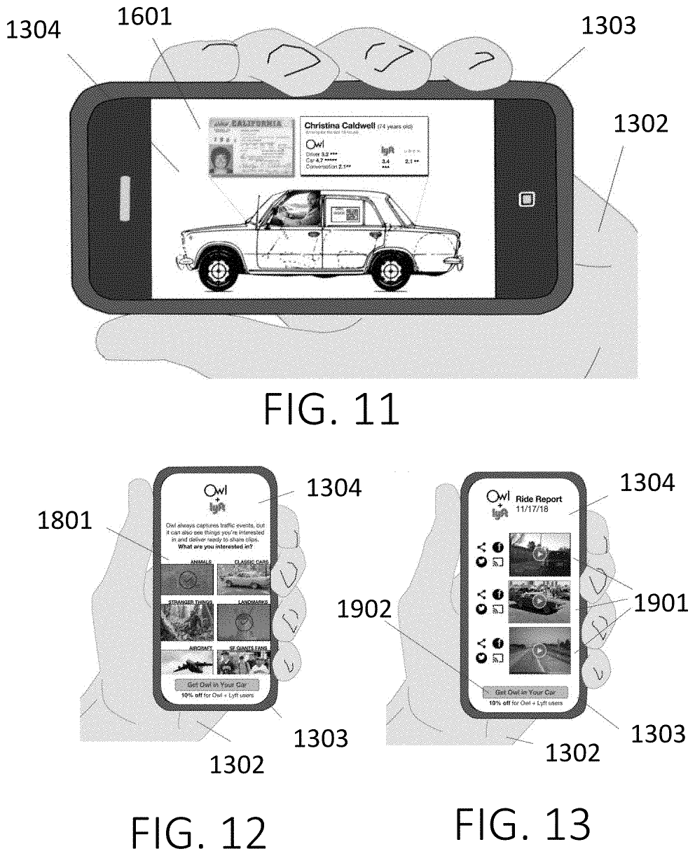

According to another embodiment, and referring to FIGS. 10A and 10B, a rideshare vehicle 1102 includes a QR code 1501, in the form of a sticker, and a license plate number 1502. In this embodiment, a user may scan either QR code 1501, or the license plate number 1502 using their smartphone 1303 before entering the rideshare vehicle 1102 to reveal specific information regarding the driver's identity, driving record, ratings from other riders and other statistics and information of both the driver and the rideshare company. For example, as illustrated in FIG. 11, upon scanning the QR code 1501 or license plate 1502, the user's smartphone 1303 may provide driver information 1601, such as for example, an image of the driver's license and/or a driver profile from the rideshare company. FIG. 11 shows an image of the actual driver, for example captured by the user's smartphone 1303 to scan the QR code 1501, and reveals that the actual driver is not the driver registered by the rideshare company or appearing on driver's license 1601. The user may use this information to determine if he or she wants to enter the car and proceed with the scheduled ride or cancel the ride and walk away.

Alternatively, according to another embodiment, each vehicle can actively transmit its information using appropriate Bluetooth beacon technology. The driver's face can be scanned using the cabin-view camera 214a of client device 101 and his or her identity confirmed using image recognition software. This information may be sent to an awaiting user's smartphone when the vehicle approaches the user at the pickup location. Once vehicle and driver are identified, the user's smartphone may retrieve driver ratings and reviews and other pertinent information from the memory of the client device 101 located in vehicle 1102, or the remote server 1103, or a third-party service using (for example) a web API.

According to another embodiment, client device 101 records video and audio of the driver and how he or she interacts with the passenger during a ride. Client device 101 continuously monitors the driver (as well as the passenger, as described above) for any uncomfortable actions and conversations towards the passenger, including any threats or sexual comments, swearing, smoking, or similar actions. Audio and image recognition algorithms continuously analyze the audio and video from he cabin-facing camera as further described above. If any recognizable events occur, client device can announce to the driver that the inappropriate behavior is being recorded and stored in the cloud server and cannot be erased . . . and that such behavior should stop. Client device 101 can summon a police officer if the inappropriate behavior continues, or distressed responses and telling gestures from the passenger are detected.

According to another embodiment, client device 101 may receive onboard diagnostic codes through an electrical connection with the vehicle's OBD connector and may transmit any pending diagnostic issue with the vehicle to the smartphone of the user before entering the vehicle. This information can be used to help inform the user so he or she can decide if it is safe to enter the vehicle and continue with the ride.

According to another embodiment, if a driver does not want to have a rider ever again ride in his or her vehicle, he or she can instruct client device 101 (through a specific hand gesture, a voice command or another input means) to add the rider's ID to a “no-ride” list wherein the driver will never again be matched to a ride request from that particular user.

According to another embodiment, auxiliary client devices 106, such as for example, security camera-based systems, networked with the system 1100, as well as the cameras of client devices 101 of any of many vehicles 1102 operating within the system 1100 are used for scanning areas of interest, looking for people of interest and objects of interest, using appropriate facial and object recognition software, as is understood in the art. For example, prior to a rideshare vehicle arriving at a pickup location, client device 101 of the approaching vehicle can connect with stationary or other cameras 106 located at the pickup location and request information regarding an open area suitable for pickup, perhaps one that has few people, or perhaps an easily recognizable reference object, such as a red bench, and can also use facial detection (using information located in the person's profile) to locate the awaiting user standing in the crowd. In such instance, client device 101 located in the approaching rideshare vehicle may receive information about a red colored bench (perhaps transmitting a still image of the general pickup area) for the driver's review. The driver of the approaching rideshare vehicle can then suggest to the waiting user to “meet at the red bench located just to your left.”

Similarly, according to another embodiment, facial recognition software and the various cameras in the area, including both stationary cameras 106 and cameras located in other clients 101 in rideshare vehicles 1102 in the area can scan the faces of people in a nearby crowd for the user of a specific rideshare vehicle using a sharing request as described above, for example with reference to FIG. 6. If a match is found, the calculated location of the person with respect to the location of the rideshare vehicle can be used to instruct the rideshare driver how to locate his or her passenger, by announcing or displaying the instructions on display 216 of client device 101 to the driver.

For example, after locating the user (e.g. a passenger waiting) in the crowd, the client device 101 may instruct the driver to advance slowly 100 feet and to announce the precise location of the passenger and possible descriptive attributes, e.g., the user on the left, 100 feet in front, wearing a yellow hat. A photograph of the awaiting user may preferably be displayed on client device 101 (for example, downloaded from the user's account profile, uploaded by the user with the ride request, or taken by another client device who recognized the awaiting user) so that the driver may quickly and easily compare the user's displayed face with the faces of the crowd. In addition to verbal directions, client device 101 may project visual cues onto the windshield of the vehicle (similar to a heads-up-display HUD system) to help the driver safely locate his or her awaiting passenger. According to another variation of this embodiment, as described above, client device 101 can run an augmented reality (AR) overlaying program that is used in combination with a facial recognition software program. First, the facial recognition software is used to locate the correct user, as identified by scanning the faces in the crowd. Then, as the front view of client device 101 (as seen through forward-view camera 214b) showing the crowd is displayed on client device 101, the now located “correct” user's face can then be highlighted (with a small dot or square) on display 216 of client device 101, overlaid on the real-time displayed image of the crowd. The driver can more easily find the correct user simply by letting client device 101 to the locating. The driver can then concentrate on driving.

According to another aspect of this embodiment, from the perspective of the awaiting user in the crowd, a live view of the forward-view of camera 214b of client device 101 of the approaching rideshare vehicle 1102 may be transmitted as a live feed to the user's mobile device, for example using playlist or manifest file as described with reference to FIG. 5 where the linked video files are real-time video feed files. This will help the user locate his or her approaching rideshare vehicle. In this embodiment, a rideshare user using the accompanying application can request a ride and can indicate a preference for getting a rideshare vehicle that is equipped with a client device 101, for reasons of safety and convenience. According to another embodiment, the application that is used to request a rideshare vehicle may indicate to the user all available rideshare vehicles so equipped with a client device in the area and an estimate of arrival. The user may request one of these vehicles and when a request is made, the application will notify all rideshare drivers (through their client devices) of the request so that they may accept the request before other rideshare drivers (those not using a client device) are either notified or can respond.

According to another one embodiment of the invention, when a user enters a rideshare vehicle, cabin-view camera 214a of client device 101 will detect this through sounds and movement detection. Once detected, client device 101 will send notification to the owner of the rideshare account and also set the official start time of the ride.

According to another one embodiment of the present invention, client devices 101a-d from rideshare vehicles 1102a-d moving within an area of interest and with the use of other cameras (such as stationary security cameras 106) are used to help estimate the general density of a crowd located at the area of interest to anticipate a volume of rideshare requests from that location. Facial recognition software may be used to quickly analyze and count faces in a sample area of the crowd to estimate a density value. In addition, Bluetooth signals from people's mobile devices may also be detected, using conventional known techniques, and the detected number of sources counted to help assess crowd numbers and/or provide a more accurate assessment. Object recognition software may be employed to recognize people with bikes, skateboards, and people waiting at a bus stop and use this information to exclude these people from the calculation.

According to another embodiment, a method for facilitating passenger pick-up after a user requests a ride from a ridesharing provider comprises transmitting a unique image, code or pattern of colored light and/or illuminated flashes to a user's smartphone display with instructions for the user to hold their smartphone up towards the arriving vehicles. The driver is given the same image, code or pattern of colored light and/or illuminated flashes, displayed on display 216 of his or her client device 101 within vehicle 1102. The driver can then carefully scan the crown for any presented smartphone display and compare the image, code or pattern of colored light and/or illuminated flashes to the same presented on display 216 of client device 101. If there is a match, then the driver has found the correct user waiting for his or her vehicle and a connection has been made. Alternatively, a known image, code or pattern of colored light and/or illuminated flashes could be sent to the correct user in the crowd with instructions to direct the smartphone display towards the arriving rideshare vehicles. The driver, in this variation of this embodiment, understands to search for a specific pre-assigned image, code or pattern of colored light and/or illuminated flashes. The pre-assigned image, code or pattern of colored light and/or illuminated flashes could be pre-selected from a list, or custom generated by the user at some point prior to the rideshare vehicle arriving at the pickup location. Additionally, according to another aspect of this embodiment, client device 101 automatically scans the surrounding area, based on the field of view of forward-facing camera 214b, for a specific image, code or pattern of colored light and/or illuminated flashes, displayed by a user located nearby. If a match is located, the driver is alerted by an appropriate sound, tactile alert, or automated voice, etc.

As shown in FIG. 4, according to another embodiment, a vehicle 1102 may also include an illuminating-generating device 1701. In one embodiment, the illuminating-generating device includes at least one forward-facing LED 1701, but preferably an array of LEDs, integrated in the housing of client device 101. In an alternative embodiment (not shown), illuminating-generating device 1701 comprises a larger illuminated panel mounted on the vehicle 1102, separate from client device 101, but preferably controlled by the client device 101, for example via Bluetooth, WiFi, or the like. Regardless of the type of illuminating-generating device 1701, the device 1701 is mounted so that the generated illumination is in full view to at least some people located outside the vehicle. According to one embodiment, the awaiting user is provided a link on his or her smartphone (or is already running a supporting rideshare application) which allows the user to actively and in real-time control the illuminating-generating device 1701 using their smartphone to assist the user in locating its arriving vehicle. In one embodiment, the user may vary the color, control the flashing sequence, and/or intensity of the illumination of the illuminating-generating device 1701. Since the user actively controls the illuminating-generating device 1701 of the approaching correct vehicle 1102, it will become immediately apparent to the user if the rideshare vehicle requested has arrived.

According to another one embodiment, client devices 101 function as a standardized, service-agnostic rideshare beacon, similar in function to the pill-shaped LED display (called “amp”). In one embodiment, each client device 101 includes appropriate circuitry to function as a Bluetooth Low Energy (BLE) beacons. A corresponding application running on a user's phone can detect the beacon signal when any rideshare vehicle using client device 101 is nearby. The signal can report the GPS location each time a vehicle with client device 101 is detected. This arrangement enables redundancy for the location reporting service since now both the client device and one or more smartphones can report the location of any detected client device. This allows for a potentially more accurate location signal to be available for both the driver and the awaiting user, since accurate location information is often difficult to obtain in urban areas with tall buildings and reflective surfaces.

According to another one embodiment, the ridesharing cloud service 1103 associated with system 1100 can provide location and availability to any third party rideshare service. With this arrangement, a driver can install client device 101 in their vehicle and then use the accompanying software running on client device 101 to log into whichever rideshare service they wish to use and then enable the client device location service to the selected rideshare service. Each client device 101 continually updates location and availability status to all enabled rideshare services.

According to another aspect of one embodiment, a rating improvement function is provided in ridesharing applications. Some drivers have recognized that providing riders with simple conveniences (“gift-giving”) results in a higher chance that the rider will provide a good rating and ride review. The conveniences generally include providing bottled water, candy, gum and other simple light snacks, magazines and newspapers, and offering a power cord for charging their mobile devices during the ride. To help correlate the connection between providing such conveniences and receiving a good rating, in one embodiment, using the cabin-view camera 214a, client device 101 detects such gift-giving with its object and movement recognition functions and keeps track of which conveniences or gifts the driver offers to a passenger, which of these gifts the passenger accepts and which are declined, and how the passenger rates the driver after the ride has completed. By compiling this data, the drivers may better understand which extras or gifts make the passengers most happy. For example, if any driver offering a power cord results in a 78% increase in getting a 5-star rating, then client device 101 can suggest to the driver to offer this extra. In one embodiment, client devices 101 in multiple ridesharing vehicles 1102 in a system 1100 report the monitored data to cloud-system 1103, where data for multiple client devices is analyzed and the resulting recommendations or improvements are shared to all drivers in the system 1100.

According to another embodiment, client device 101 records and analyzes passenger behavior and passenger countenance and how he or she responds to various driver interactions. Cabin-facing camera 214a recoding passenger face vide is analyzed by client device 101 to detect facial micro-expressions. For example, software by a California-based Emotient, uses a simple digital camera to analyze a human face and, based on selected points of interest on the subject's face determines whether that person is feeling joy, sadness, surprise, anger, fear, disgust, contempt or any combination of those seven emotions. Using the similar software on a video sequence produces even more interesting results, because the software can track the fluctuations and strengths of emotion over time, and even capture “micro-expressions,” or little flickers of emotion that pass over people's faces before they can control themselves or are even aware they've registered an emotion. In one embodiment, client device 101 can keep track of how each passenger reacts to various interactions and events that occur during a rideshare ride and use this information to help advise or train drivers into being “better” drivers. By using a simple feedback confirmation, each driver will know when his or her changes to passenger interactions are working and when they are not working.

For example, analysis of the video data from cabin-facing cameras 214a can yield an accurate assessment regarding the passenger's emotion and level of approval in response to an “event,” such as a human interaction or a human experience (e.g., being offered a bottle of water). Keeping track of such results overtime, including how each passenger responds to various driver interactions, optionally across multiple drivers of multiple vehicles, allows drivers to be instantly informed how to interact with the same passenger during future rides. For example, when a passenger named “Tom Watson” rides in a rideshare car, client device 101 has noticed in the past that Tom always smiles and actively converses with any driver during a ride. Tom never looks at his smartphone and never reads when in the car. He also regularly declines bottled water when it is offered to him by the driver. Based on this data about Tom, the next the driver has Tom as a passenger, or the next driver that gets Tom as a passenger, may be given a “heads-up” regarding the passenger interaction profile by offering suggestions how the driver should interact with Tom. The suggestions could be simple and transparent to both the driver and the passenger, displayed on display 216 of client device 101. In this example, the display may show: “Tom enjoys conversation, and rarely uses electronic devices, and usually declines water.” The driver can then use this information to better plan his or her interactions with the passenger during the ride. Such automatic analysis of a passenger's involuntary responses to various movements during the ride may also help inform the driver how to improve his passengers' ride-experience. Client device 101 can watch when the passenger appears unhappy and correlate the unhappy moment to an event, movement or interaction. Continuing with the example above, if passenger Tom grimaces every time the driver brakes, the current driver and future drivers can be alerted to brake less aggressively for Tom's comfort. Client device may watch Tom when the driver brakes more gently to “see” if Tom responds differently and to confirm that the correction was effective, or ineffective. The driver can then fine-tune the passenger's ride-experience in real-time for the better.

In addition to learning if a passenger is happy or not, facial, voice, and emotional recognition techniques can be used to detect environmental conditions within the vehicle, where action may be required. For example, if cabin-view camera 214a of client device 101 detects that a passenger is extensively fidgeting with his or her seatbelt, it could mean that something is mechanically wrong with the passenger's seat belt and action must be taken immediately. In such instance, the driver would be appropriately notified to take corrective action (e.g., pull over and fix the belt mechanism). Another example has a passenger continually waving his or her hand in front of his or her face. This gesture is picked up by client device camera 214a and could be interpreted as either meaning that it is hot within the vehicle, or that there is a foul odor in the cabin. In response to such clues, the vehicle could be connected to client device 101 so that the climate controls are automatically adjusted to correct the apparent issue, as conveyed by the passenger's gestural movements, or the windows automatically lowered to admit fresh air. According to another aspect of one embodiment, client device 101 supports a mode to help rideshare drivers sell client devices to their passengers during or after a ride. In this embodiment, client device 101 preferably includes a “demo” mode wherein a passenger's smartphone is linked to a client device so that the smartphone mimics the actual client device. In this mode, the passenger's smartphone will include a live feed of the two cameras 214a and 214b of the actual client device 101 and the passenger may manipulate the different buttons provided on the demo-screen to test-out the different features client device offers. For example, referring to FIG. 12, a user's hand 1302 is shown holding a smartphone 1303 with a display 1304 showing an exemplary feature of the present client device 101. Here, for example, a user is taught that client device 101 may watch out for select items of categories of items 1801, such as landmarks, or animals which may enter into the field of view of forward-facing camera 214b as vehicle 1102 drives around. The user, in this example, may select categories for client device to search and store. Client device 101 will capture all that it sees, but if object recognition software identifies an object that matches a selected category, client device will create an “object of interest” video clip (as described above with reference to FIG. 5) and store that clip into a passenger-accessible storage location. FIG. 13 illustrates a different GUI of the demo-mode and it shows a user's hand 1302 holding a smartphone 1303 with a display 1304 showing three separate video clip files 1901, each representing ride reports, which are video clips stored by client device 101 of previous rideshare rides.

According to this embodiment, if the user would like to purchase a client device 101 for use in his or her own personal vehicle, he or she may order a client device simply by pushing a single button 1902 on his or her smartphone. If a sale is made, or confirmed by the passenger, the driver may receive a sales commission for that sale. The user's smartphone may then display a check-out page through which payment and shipping information may be filled-in and confirmed. Alternatively, a purchase of client device may be transacted with a verbal acceptance of a purchase offer is by the passenger, which may be recorded by the driver's client device 101.

According to yet another embodiment, the evidence generation aspect of cloud system 100 is applied to ride sharing applications. For further description of this aspect of cloud system 100, see the specification of the incorporated PCT/US17/50991 patent application. Most conventional rideshare rides are made without a dispute, argument or incident. However, should a dispute occur, conventional rideshare services currently offer little support that would benefit the passenger. In such instance, the passenger must contact the company by phone or email to try to resolve the dispute but the response from the company may be misleading, misunderstood or lacking empathy. In response to this situation, and according to another one embodiment, a passenger may be able to receive a copy of the video footage of vehicle cameras, including for example the cabin-view camera 214a and the front-view camera 214b, recorded during the ride. In one embodiment, the evidence file (also called the ride history file), preferably includes the video footage and driver and car information, date, and time of the ride, as well as a description of the route taken, including pickup and drop-off addresses and possibly an image of a map showing the route. The evidence package may be sent as a single file to the user's email address, or as a text to the user's smartphone, if requested, or automatically sometime after the ride ends, for example as link in a ride receipt notification. The package is preferably sent by a single action, such as by the driver pushing a single button on client device 101, or by voice, wherein either the driver or the passenger simply states “send evidence package” within the vehicle. When this happens, client device 101 “hears” the instructions and sends the evidence package to the contact location on file and responds: “evidence package sent.” According to one embodiment of the invention, the passenger can also instruct client device 101 to send out the evidence package by using innocuous hand gestures or phrases that don't raise suspicions in sensitive conditions, such as in situations of driver harassment. In such instance, client device cabin-view camera 214a captures and understands the particular gesture and carries out the request without audibly confirming the request, but confirming through email or text directly and only to the passenger's smartphone.

According to another one embodiment, forward-facing camera 214b and cabin-view camera 214a of client device 101 records video footage of rides of a driver during a predetermined time period and supporting software analyzes the driving skills of the driver based on specific criteria and the video footage. For example, the analysis determines if:
a) The driver speeds;
b) The driver's vehicle is too close to other vehicles;
c) The driver yields properly to pedestrians;
d) The driver obeys traffic lights;
e) The driver is distracted while driving;
f) The driver keeps both hands on the wheel;
g) The driver uses turn signals properly; and
h) The driver uses his or her phone while driving.

Based on this collected information, optionally including reports from neighboring devices in a networked system 1100, the supporting software generates an independent safety rating of each driver and stores the rating for each testing period in the driver's profile. Should the rating drop below a threshold value, each passenger will be notified of the driver's rating and can decide if he or she wishes to decline the ride. A passenger can also inspect a driver's profile (when a driver accepts a ride request) regardless of the driver's safety rating.

According to another aspect of this embodiment, cabin-view camera 214a may also monitor a driver's eyes during a ride and send live-view alerts to a passenger, employer, or ride sharing service, whenever it is determined that the driver's eyes are not looking forward and the driver appears to be distracted for a predetermined period of time, such as if he or she is looking down at his or her phone for more than 3 seconds or so. The time can vary depending on the measured speed of the vehicle. If the vehicle is moving at 60 mph, then the allowed distraction time is essentially zero. If the vehicle is moving at 15 mph, then perhaps the allowed distraction time is 3 seconds. Also, client device 101 may automatically alert the driver with a sound whenever it detects a driver distraction of more than a predetermined length of time. Should the passenger feel unsafe after being notified of a distracted driver, he or she may select options on his or her mobile rideshare application allowing him or her to request rerouting to the nearest safe drop-off location, cancelling the trip, or by confronting the driver, asking him or her to immediately correct his or her unsafe driving performance. Client devices 101 from other vehicles 1102 can monitor how other drivers handle driving situations at specific locations, keeping note of the conditions at the time, and use the compiled information as a reference when reviewing another driver at the same location and conditions.

According to another embodiment, a passenger may connect his or her smartphone wirelessly to client device 101 during a ride for live-streaming video. The passenger may record and save the incoming video data, but only during the ride. Video streaming to the passenger's smartphone is blocked before and after the ride. Connection to client device can be made using conventional techniques, such as using local WiFi direct. To authenticate the passenger's device, as for example further described in the incorporated provisional application, the passenger displays a provided QR code on their smartphone to the cabin-view camera 214a of client device 101. Client device 101 can read the code and verify that the smartphone is owned by the approved passenger, thereby allowing video streaming to commence. The passenger may instruct his or her smartphone to live-stream to a third-party, located outside the vehicle. Crash detection alerts (as detected by either the passenger's smartphone, or client device 101) may also be sent to a third-party.

Once a passenger's smartphone is connected to client device 101, the passenger may tap on the screen of their smartphone to tag an event shown in the live-feed video, as viewed from the cameras 214a and 214b of client device 101 as further described above with reference to FIG. 5. In this embodiment, the tagging action by the passenger on the passenger's own device would be treated as an additional input (as described in step 701 of FIG. 5) and cause a set amount of video before and after the tag to be saved as a separate video clip. Supporting software running on the passenger's smartphone would keep track of such tags and the stored video clips may later be reviewed by the passenger and used or shared as desired.

According to another embodiment, a passenger may use client device 101 to control a limited number of operations of vehicle 1102, without driver permission or intervention. Client device 101 is preferably configured to receive and understand both voice and gesture commands by the passenger (or the driver). The passenger may control the volume levels of the radio, including turning the radio off, simply by, for example, moving his or her hand in a controlled and predetermined manner, or voicing a command “Volume Up” or “Radio Off,” or similar. The passenger may use similar command actions to control the climate controls.

According to another aspect of this embodiment, since client device 101 is able to read and understand voice and gesture commands, should a passenger leave something in the vehicle after being dropped off and while the vehicle drives away, the passenger may shout for the driver to stop and wave his or her hands in the air. According to this embodiment, client device 101 is designed to “listen” for the sounds of the shouting (“STOP”) and detect arms waving in the air in its video feed to deduce that something is wrong and that the driver should stop the vehicle. In such instance, client device would alert the driver of the situation, by sound and/or lights.

According to another embodiment, during or at the end of a ride, a passenger may request to give a video review using client device 101. In such instance, a review mode may be initiated which allows for the video and audio recording of a passenger's review of a driver. The recorded review is then stored and made available to future users. A passenger may alternatively provide a driver with a review by using gestures, such as holding up 1-5 fingers to cabin-view camera 214a to convey a 1-5 star rating. The rating will be stored in the driver's profile.

A rating between passengers and drivers may each be linked to video evidence during a ride to confirm the particular rating, especially useful when either the driver or the passenger is given a poor rating. For example, if the passenger is intoxicated and gets sick (i.e., throws up) in the vehicle, the driver can give the passenger a poor rating and the rideshare company can charge the passenger a “clean-up” fee to cover the cost of cleaning up the mess. If the passenger disputes the charge, the driver and the passenger will have immediate access to the video footage recorded by client device during the ride, showing, in this example, the passenger throwing up in the back seat.

According to yet another embodiment, a training function is provided to improve the driving skills of rideshare drivers. In this embodiment, client device 101 includes a “driving test mode” wherein a driver follows prescribed driving instructions during a test, which are audibly conveyed through speakers located within the vehicle. The test is preferably taken on a closed, controlled course. During the test, the driver is monitored in real-time by coaches, using cabin-view camera 214a and forward-view camera 214b. The coaches are there to provide instant corrective feedback and review of the driver as he or she carries out each instruction. For example, the driver is instructed to follow between the cones (which define a road, for example) and then make a left at the intersection. For example, if a driver performs a “rolling stop” at a stop sign (not making a complete stop before turning left), the remotely located coach can take notice of this illegal and unsafe move and inform the driver by intercom communication of the error. The driver, in this case, may be asked to redo that portion of the test.

According to yet another embodiment, a vulnerable passenger feature is provided. There are times when the passenger of a rideshare vehicle is considered a “vulnerable” person. This would include children, the elderly, and persons with disabilities impeding their independent use of ridesharing services. According to this embodiment, client device 101 is configured to operate in a manner to help serve, communicate with and protect the vulnerable passenger, as needed, during the ride.

In conventional rideshare services, a parent or guardian (hereinafter referred to as “sponsor”) may help the vulnerable person get into the ridesharing vehicle and may help to buckle them in.

The driver would then drive to a planned destination, but he or she is not expected to otherwise help the passenger, during the ride.

According to this embodiment, a communication link is made available between the sponsor(s) at either or both ends of the ride, wherein a remote smartphone may show a live-stream view from both cabin-view camera 214a and forward-view camera 214b during the entire ride. Additionally, client device 101 may continuously scan for any unapproved language or music (as defined by a user profile prior to the commencement of the ride) and can notify the sponsor if such an event occurs. The sponsor may at any time directly communicate with the driver and instruct the driver, as needed. Live-streaming can be encrypted with password protection so that only the sponsor may view any images recorded by client device 101 (at least by cabin-view camera 214a). Client device would record the video, but only the footage from the front-view camera 20 would be viewable by authorized people other than the sponsor. The sponsor may give permission for others to view the encrypted cabin-view footage, if desired. The driver's image would preferably be obscured in all footage sent to the sponsor, but only when the driver is located in his or her driver's seat. The obscured image of the driver may be revealed at a later date by obtaining appropriate permission.

To further protect the vulnerable passenger, according to another embodiment, a specially designed rideshare vehicle includes separate lockable compartments wherein the passenger is secured in their compartment by the sponsor and only the receiving authorized sponsor is allowed to open the compartment. Absent emergency conditions, the driver does not have access or permission to enter the locked compartment without permission from the sponsor. A code may be sent to the sponsor's smartphone at both ends of the ride which allows only authorized people access to the locked compartment. In the event of an emergency, a frangible component may be destroyed to provide access to the compartment. In such an event, the sponsor would be notified and live-streaming would commence.

According to another aspect of one embodiment, the sponsor may require that the vehicle transporting a vulnerable passenger must plan the route so that a certain number of other client device-equipped rideshare vehicles also be within a certain predetermined distance so that one of these nearby vehicles may quickly intervene and help the vulnerable passenger, if necessary, or if summoned either by the driver, the passenger, or automatically in response to preset conditions being met, such as specific body movements or sounds, as detected by client device 101, or if the main vehicle breaks down, or is pulled over in a traffic stop. Client device 101 may further monitor for any specific known sounds and visual clues, such as police siren and lights, suggesting a traffic stop is occurring. The sponsor will be notified directly by the client device if such an event is detected.

To further protect a vulnerable passenger, in one embodiment geofencing technology is used to ensure that a driver follows a prescribed route at prescribed speeds, each with an allowed margin of variation, such as plus or minus ¼ mile and plus or minus 5 mph. If the vehicle exceeds these allowed parameters of travel, the sponsor will be notified by his or her smartphone. In addition, client device 101 can detect that the vehicle is “out of bounds” or “off route” and can remind the driver to follow the route and if he or she fails to do so, an alarm can sound, and authorities automatically summoned. In one embodiment, client device 101 is connected to the controlling circuitry of the vehicle so that in such instance where the vehicle has left the allowed route for a prescribed period of time, without contacting the sponsor and without explanation, client device may instruct the vehicle's onboard computer to reduce power to the engine, or even stop the engine so that the vehicle is not able to escape the area with the vulnerable passenger.

According to another aspect of one embodiment, entertainment may be controlled by a sponsor for a particular ride, for example when the passenger is a child. The client device 101 may be configured to entertain the child through music, sounds, education lessons, video, etc, so that the child will remain engaged and therefore controllably distracted. The entertainment content may be pre-provided by the sponsor selecting from lists using the supporting mobile application prior to the commencement of the ride. The entertainment may be dynamic in its selection so that the child's mood and emotion may be monitored, as described above, and the type of content adjusted to “reset” the emotion. If the entertainment is reviewing a school lesson, and the behavior of the child is determined to be bored or frustrated, the client device could alter the entertainment to play a cartoon for a short while, etc. Similar features may be provided for other vulnerable passengers to help them feel comfortable during a ride.

According to another embodiment of the invention, client device 101 is selectively connected to stationary cameras in auxiliary devices 106 located at specific locations along the route of a rideshare ride. At any time during the ride, the passenger may select a location along the route by pressing any of the highlighted locations displayed on the passenger's smartphone display. Once a location is selected, for example, a coffee shop, video-streaming from that location's video cameras will commence on the passenger's smartphone. The passenger will be able to determine if there are any seats available at that location, and if so, can request that the driver stop at that location. The businesses would have agreed to join the service and connect their cameras to the larger network 1100—the network of which client devices 101 are all connected. Apart from a live-video feed from the selected location, other information may be acquired, such as the next showing of a particular movie, when a nearby movie theater is selected.

According to another embodiment, since client devices 101 include forward-view camera 214b, as vehicles 1102 drive around an area, the recorded video footage be used to create a collection of street-view images and video clips corresponding to routes, street addresses, POIs and GPS locations, similar to Google's “Street View,” but likely more up-to-date, since rideshare vehicles 1102 are always operating everywhere. The video footage can also be used to spot defects in the road that the vehicle is being driven on, such as potholes, and report the damage with a still picture of the damaged road and the address or GPS location to the appropriate city department of transportation as repair notification.

According to another embodiment, a passenger or driver in a rideshare vehicle can request help from other nearby vehicles 1102 with client devices installed. At the request for help, live video streaming can commence to nearby client devices 101 so that others can see what is going on in the distressed vehicle.

Another problem that occasionally affects rideshare passengers occurs when a rideshare driver gets pulled over by the police. In such instance, the passenger is forced to patiently remain in the vehicle until the officer allows the driver to leave. This could easily take more than 30 minutes. According to another embodiment, when a rideshare driver has a client device 101 installed, the cabin-view camera 214a will detect the tell-tale signs of a police traffic stop—the flashing red and blue lights. Once the lights are detected, client device 101 can request confirmation from the driver that he or she has just been pulled over by the police. If confirmed, client device 101 will contact another available rideshare vehicle in the area and ask to drive to the location of the stopped vehicle so that the passenger can transfer vehicles and continue on his or her ride. Client device 101 can further contact local emergency services to explain the situation using pre-recorded messages to inform them that there is a stranded passenger in ridesharing vehicle that just got pulled over and they feel unsafe and have an alternative vehicle en-route with information to officer. If allowed, the passenger may transfer to the secondary rideshare vehicle when it arrives.

According to another embodiment, client device 101 may provide to a remote site an automotive service report including all current OBD codes reported in the rideshare vehicle and using GPS to keep track of when and for how long the rideshare vehicle visited a service station. According to another embodiment, a driver incentive mode is provided. One problem of rideshare services is that if a large number of drivers stop working at the same time, the service for all riders will be affected. To help encourage drivers to drive at different times, an incentive feature is provided wherein a driver uses their smartphone to shop online and when they find an item that they would like to save up for, they can send details of that item to client device 101 located in their vehicle, including a picture of the item, a description and the cost of the item. From that point on, client device 101 will use the received information to both help the driver save towards the item and encourage the driver to work towards buying the item. According to the invention, a picture of the item will periodically be displayed on display 216 of client device 101 to act as encouragement to continue working. The user can use a supporting mobile application to set aside a certain amount of earnings from the rideshare work towards buying the item, such as $5 per day, or 3% of the earnings each week. The program can set aside the money and further encourage the driver to continue to work hard by showing how much is needed before the item can be purchased. This can be done with a dollar amount displayed on the client device 101 every so often, or whenever the driver indicates that he or she wishes to end work for that day, or the amount needed can be show as a graphic on display 216 wherein a pie chart can be displayed next to the item of interest. Human nature is very powerful and this form of encouragement will prove to be a powerful tool in keeping the drivers working hard at their ridesharing job.

According to another aspect of this embodiment, client device 101 may also scan for items in its field of view that may interest the driver, based on his or her input or profile information. Once scanned items are recognized and matched as items of interest to the driver, the item may be displayed on display 216, for the driver's approval and desire to purchase. Client device 101 can then connect to the Internet to find the lowest price for the item and again use the above method to encourage the driver to work hard towards purchasing the item. The client device may automatically make the purchase using set aside funds once the goal is reached. Client device 101 may use automated voice to further encourage the driver, such as by saying: “Only $15 away from purchasing that new set of speakers you always wanted.”

According to yet another one embodiment, client device 101 can be used to initiate and continue a conversation with a passenger, using information obtained from the Internet and the passenger's profile. Text-to-speech processing and voice simulation can be used to converse about topics that interest the passenger. This allows the driver to focus on driving the vehicle. Points of interest (POI) can also be announced to the passenger when client device 101 matches current location of the vehicle with the location of known POI. For example, client device can announce that a celebrity lives in the house to the left.

According to yet another one embodiment, the third-party video sharing method described above may be provided in a ridesharing system 1100. In this embodiment, client devices 101 may be used to help locate an object or person, or pet, etc. as they drive around in ridesharing vehicles 1102, either with a passenger, or without. Each client device 101 will be able to monitor a small area in front of the vehicle, but collectively and as each drive around, the effective coverage is substantial, of course depending on the number of vehicles. An appropriate object-recognition function is provided within each client device 101 to watch for any desired object, including a person or an animal. An image of the item of interest can be uploaded to each client device in the system. For example, animal control services may send out a request to keep a watch out for a mountain lion that was recently spotted in a particular neighborhood. Client devices can be used to help locate the whereabouts of the mountain lion. In this case, a stock photo of a mountain lion can be used to help the object-recognition software compare and identify any similar looking objects in the collective field of view of all operating client devices over a period of time.

According to yet another one embodiment, client device 101 may be used to continuously monitor traffic and other events that its forward-view camera 214b captures during a ride, or even when the vehicle is stationary or parked. Client device 101 may be used as evidence to review or authenticate a particular event it captured on file. The events may or may not involve the vehicle or the driver. For example, client devices 101 in ridesharing system 1100 may be further connected to other networks of client devices with similar functionality. For example, networked via a cloud system 103 and 1103, client devices in multiple networks can request and respond to video sharing requests as described with reference to FIG. 6. As described above, means are provided to continuously store captured footage locally on the device itself, and also at a remote server. The stored footage would be kept for a period of time, allowing the driver, the passenger, or a 3rd party to request access to the footage for review as needed. In such instance that the event does involve the vehicle and the driver, such as the driver accidentally hitting another vehicle in traffic, the system will detect this automatically and will not only retain a video and audio record of the event, both before, during and after, but will also become part of the driver's driving record, which is accessible for review by any future passenger. Such stored data on the events may be provided to other rideshare companies, and their companion software applications.

It should be noted here that the above-mentioned embodiments may be used independent of a rideshare or car-share company, or may be integrated or used with any such company. The present features and embodiments described herein are essentially agnostic, in the computer sense, in that the hardware and operating software of the present device and system are compatible with many types of platforms or operating systems currently used today, including those systems of current rideshare and car-share companies. Simple API level service integration may be used to enable developers to create software applications which integrate the features and embodiments described herein into any application experience.

According to yet another one embodiment, client device 101 may be used to introduce target advertisement to the passenger during a rideshare ride. Typically passengers will either use their smartphone, or look outside the window. For the most part, the time spent in the vehicle getting to their destination is a waste of time. Very rarely do they have to use the time to work. This invention offers the passenger an opportunity to lower the cost of the trip if they promise to watch a few ads and comment on them during their ride. They can select the type of ads they would like to view. According to this embodiment, a passenger enters a rideshare vehicle to be driven to a destination following along a prescribed route, as determined by an algorithm and based on several factors including known traffic conditions, tolls, time of travel, etc. Regardless, once they enter the car they are introduced to the deal (either by the driver verbally, signage, push notification or an announcement on installed device). The deal includes a reduction in the trip cost (X dollars), if the passenger agrees to view a certain number of ads during the ride. Or, alternatively, a certain amount can be deducted from the ride for each ad viewed during the trip.

According to this embodiment, the ads can be managed and transmitted to the passenger's smartphone using an ad-program (email or text link) through the client device 101, or directly. Once the ad completes, the passenger will be shown one or two simple multiple-choice questions regarding each ad. The passenger must answer the questions correctly to get the discount. The user can decide how many ads he or she wish to review and can cancel anytime. A growing discount amount is shown on the phone display to encourage the passenger to watch another ad. For example, each minute-long ad pays 25 cents towards a trip, up to a maximum of $5.00. The ad-program knows the length of the ride and can plan the number and length of ads accordingly. Client device can monitor the passenger's face and phone to make sure that he or she is watching the ad and record the facial reaction to the ad, storing the data and providing it to the advertiser as invaluable marketing research. A link for each ad viewed (or for each selected ad viewed) can be sent to the passenger by email, text, etc. to provide additional information. The present ad-program would keep track of all details, including which ads are shown to whom in which city and would manage payments or credits to the passengers and/or directly to the rideshare company or driver. According to this embodiment, the ad-program would manage the ads viewed so that each passenger would only view new ads (no repeats). The ad-program can use the information provided in the passenger's profile to better select the ads for each passenger.

According to yet another embodiment, an advertisement billboard view counting feature is provided. The number of views that a particular advertisement billboard has experienced over a period of time is very valuable information to advertising agencies and billboard owners. This number was difficult to obtain. Prior methods for obtaining such metrics use 3rd party traffic data to estimate a number of cars passing a particular billboard, along with estimates of demographics and visibility. Each estimated value accumulates error in the final number, leaving the accuracy suspect and unreliable. According to another embodiment, billboard views are measured more directly, and are therefore more accurate.

According to this embodiment, forward-facing camera 214b on client device 101 uses image recognition software to detect billboards in the field of view. Detailed metadata (GPS coordinates, orientation, width, height, etc.) of each billboard of interest is provided for improved tracking. For example, participating billboard owners may subscribe to the tracking system and register billboards to be monitored. Cabin-view camera 214a client devices 101 are configured to track the eyes of the driver and passengers (if any) to determine how many people actually looked out the vehicle window in the direction of the particular billboard, to measure the length of time of that the driver or passenger looked in the relevant direction (viewing the billboard), and to capture any behavioral clues or recognizable countenance of the passenger's face which may be used to determine if the passenger enjoyed the billboard advertisement, or not. In this embodiment, using video from forward-facing camera 214b, client device may optionally also count number of other cars and pedestrians in the vicinity of each relevant billboard, which could also be used to estimate additional views.

According to this embodiment, the system may provide subscribed billboard owners or advertisers with detailed impression data, which could include any one or more of the following:
a) Overall summary of ad impressions (total count of views and time spent viewing ad);
b) Number of verified impressions (directly “seen” by client devices) versus an estimated number of views (client devices which merely observed other cars/pedestrians in the area);
c) Detailed data, such as impressions by hour of day, week of year, etc. This type of information could be useful for example when choosing whether to light a billboard at night or change the content displayed on electronic billboards;
d) Demographic breakdown of views based either on passenger user account profiles, or as detected by cabin-view camera 214a, which can determine age and race of both the driver and the passenger in the vehicle;
e) Type and condition of vehicle (from OBD data) as part of demographics; and
f) Data on viewing angles or obstructions (tree or overpass partially blocking view of billboard).

As those in the art will understand, a number of variations may be made in the disclosed embodiments, all without departing from the scope of the invention, which is defined solely by the appended claims. For example, while the terms vehicle or car are used for illustrative embodiments, they should be understood with the broader meaning, including not only automobiles, but also trucks, vans, motorcycles, boats, airplanes, or other modes of transportation suitable for ridesharing and “vehicle” sharing applications. In addition, for autonomous or driver-less vehicles, the passenger-specific functionality described herein is equally applicable in autonomous vehicle applications, including driverless, remotely controlled, or the like.

It should also be noted that although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general-purpose computer ora processor.

Examples of computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. One or more processors in association with software in a computer-based system may be used to implement methods of video data collection, cloud-based data collection and analysis of event-based data, generating event-based video clips, sharing event-based video, verifying authenticity of event-based video data files, and setting up client devices according to various embodiments, as well as data models for capturing metadata associated with a given video data object or file or for capturing metadata associated with a given event-based video clip according to various embodiments, all of which improves the operation of the processor and its interactions with other components of a computer-based system. The camera devices according to various embodiments may be used in conjunction with modules, implemented in hardware and/or software, such as a cameras, a video camera module, a videophone, a speakerphone, a vibration device, a speaker, a microphone, a television transceiver, a hands free headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module, or the like.

What is claimed is:

1. A method for verification of a rideshare passenger upon pickup, the method comprising:
receiving a request for a ride on rideshare vehicle from a rideshare passenger, wherein the request is associated with a contact identifier for a mobile device of the rideshare passenger;
generating a machine-readable code associated with the ride that uniquely identifies the rideshare passenger;
transmitting the digital machine-readable code to the mobile device of the rideshare passenger based on the contact identifier;
upon pickup, receiving an indication of a machine-readable code from the mobile device of the rideshare passenger; and
verifying that the indication of the machine-readable code from the mobile device of the rideshare passenger matches the machine-readable code associated with the ride.

2. The method of claim 1, wherein the machine-readable code is a QR code.

3. The method of claim 1, wherein the machine-readable code is a barcode.

4. The method of claim 1, wherein the machine-readable code is a digital token.

5. The method of claim 1, wherein the machine-readable code includes a sound.

6. The method of claim 5, wherein receiving an indication of a machine-readable code from the mobile device of the rideshare passenger comprises receiving audio signals from the mobile device corresponding to the sound.

7. The method of claim 2, wherein receiving an indication of a machine-readable code from the mobile device of the rideshare passenger comprises receiving image data from a display in the mobile device corresponding to the QR code.

8. The method of claim 3, wherein receiving an indication of a machine-readable code from the mobile device of the rideshare passenger comprises receiving image data from a display in the mobile device corresponding to the barcode.

9. The method of claim 1 further comprising:
receiving identification information for the passenger, the identification information including a passenger's name; and
upon verifying the machine-readable code, displaying the passenger's name on a second display in the rideshare vehicle.

10. The method of claim 1 further comprising:
receiving identification information for the passenger, the identification information including a passenger's name; and
upon verifying the machine-readable code, audibly announcing the passenger's name through a speaker in the rideshare vehicle.

11. A method for verification of a rideshare passenger upon pickup, the method comprising:
receiving a request for a ride on rideshare vehicle from a rideshare passenger, wherein the request is associated with a facial recognition signature of the rideshare passenger;
upon pickup, capturing with a camera of a client device mounted on the rideshare vehicle image data of a face of the rideshare passenger;
generating facial feature data based on the image data of the face of the rideshare passenger;
comparing the facial feature data with the facial recognition signature of the rideshare passenger; and
displaying a result of the comparing step.

12. The method of claim 11 further comprising:
receiving identification information for the passenger, the identification information including a passenger's name; and
wherein displaying the result comprises audibly announcing the passenger's name through a speaker in the rideshare vehicle if the facial feature data match the facial recognition signature of the rideshare passenger.

13. The method of claim 11 further comprising:
receiving identification information for the passenger, the identification information including a passenger's name; and
wherein displaying the result comprises displaying the passenger's name on a display if the facial feature data match the facial recognition signature of the rideshare passenger.

14. A method for verification of a rideshare driver, the method comprising:
receiving an acceptance of a request for a ride on rideshare vehicle from a rideshare driver, wherein the acceptance is associated with a facial recognition signature of a registered rideshare driver;
capturing with a camera of a client device mounted on the rideshare vehicle image data of a face of the rideshare driver;
generating facial feature data based on the image data of the face of the rideshare driver;
comparing the facial feature data with the facial recognition signature of the registered rideshare driver to determine if there is a match; and
displaying a result of the comparing step.

15. The method of claim 14, further comprising rejecting the acceptance of the request if there is no match upon comparing the facial feature data with the facial recognition signature of the registered rideshare driver.

16. A method of detecting a behavioral event by a passenger riding inside a vehicle, the method comprising:
capturing video data with a cabin-facing camera in the vehicle, the video data corresponding, at least in part, to the passenger riding inside the vehicle;
analyzing the video data to generate object data of elements in the video data potentially corresponding to predefined patterns of behavioral events;
comparing the generated object data with at least one of the predefined patterns of behavioral events to determine if there is a match; and
generating an alert in response to the comparing step resulting in a match.

17. The method of claim 16, wherein the object data includes metadata for an audio component of the video data.

18. The method of claim 16, wherein predefined patterns of behavioral events includes at least one of a passenger vomiting, smoking, or speaking profanities.

19. The method of claim 16, wherein the analyzing the video data comprises image processing and audio processing.

20. The method of claim 19, wherein the object data includes metadata corresponding to a combination of recognized image and audio patterns from the video data.
